(19) United States
(12) Patent Application Publication
(10) Pub. No.: US 2014/0087231 A1
(43) Pub. Date: Mar. 27, 2014

(54) ENERGY STORAGE APPARATUS

(71) Applicants: Tim Schaefer, Harztor (DE); Jens Meintschel, Bernsdorf (DE)

(72) Inventors: Tim Schaefer, Harztor (DE); Jens Meintschel, Bernsdorf (DE)

(73) Assignee: LI-TEC BATTERY GMBH, Kamenz (DE)

(21) Appl. No.: 14/004,580

(22) PCT Filed: Feb. 23, 2012
(86) PCT No.: PCT/EP12/00783

§ 371 Date: Nov. 22, 2013

(30) Foreign Application Priority Data
Mar. 11, 2011 (DE) 10 2011 013 618.5

(51) Int. Cl. H01M 10/50

(52) U.S. Cl. CPC H01M 10/5053; H01M 10/5004
USPC 429/120

(57) ABSTRACT

The invention relates to an energy storage device comprising a plurality of storage cells, a clamping device for clamping the storage cells together, and a temperature control device for controlling the temperature of the storage cells or a cell assembly formed by the storage cells. Said clamping device is configured and designed as a functional component of the temperature control device. Storage cells and heat-conducting elements which are suitable for use in the claimed energy storage device are also described.

The entire content of the priority application DE 10 2011 013 618 hereby becomes a constituent of the present application by reference.

The invention relates to an energy storage apparatus with a plurality of storage cells, a clamping device for clamping the storage cells and a temperature control device for controlling the temperature of the storage cells or a cell composite formed from the storage cells.

It is known that a battery for use in motor vehicles, particularly in motor vehicles with a hybrid drive or in electric vehicles, has a plurality of cells, for example lithium ion cells, electrically connected in series and/or parallel.

The cells often have to be cooled in order to dissipate the resultant lost heat. To this end, it is known to use an indirect cooling by means of a coolant circuit or a direct cooling by means of pre-cooled air which is conducted between the cells. In the case of cooling by means of the coolant circuit, a metallic cooling plate, through which coolant flows, can be arranged on the cell block of the battery, often below the cells. The lost heat is conducted from the cells to the cooling plate for example either via separate heat-conducting elements, e.g. heat-conducting rods or plates, or via correspondingly thickened cell housing walls of the cells. Often, the cell housings of the cells are realised metallically and an electric voltage is present at them. To prevent short circuits, the cooling plate is separated from the cell housings by means of electrical insulation, for example a heat-conducting film, a moulding, a casting compound or a coating or film applied to the cooling plate. The coolant circuit can also be used to heat the battery, e.g. in the case of a cold start.

Various batteries of this type are known already. For example, batteries are known from DE 10 2008 059 966 A1 and DE 10 2008 010 828 A1, the cells of which are constructed as so-called flat cells which are constructed essentially cuboidally and are arranged in a stacked manner one behind the other on a cooling plate. The cells are clamped to one another in this case by means of a clamping device, for example by means of a separate clamping plate and/or by means of clamping straps, and pressed onto the cooling plate.

A battery is known from WO 2010/081704 A2, in which a plurality of cells are clamped in a coffee bag construction between frame elements with the aid of two pressure frames and a few tie bolts. It is known from the same published document to provide resilient elements between successive cells in a battery block.

It is an object of the present invention to improve the structure according to the prior art.

The object is achieved by the features of the independent claims. Advantageous developments of the invention form the subject of the subclaims.

According to one aspect of the present invention, an energy storage apparatus is suggested, which has a plurality of storage cells, a clamping device for clamping the storage cells, and a cooling device for controlling the temperature of the storage cells or a cell composite formed by the storage cells, wherein the clamping device is designed and set up as a functional constituent of the temperature control device.

In the sense of the invention, an energy storage apparatus is understood to mean a device which is also able to accept, to store and re-emit electrical energy in particular, if necessary whilst making use of electrochemical processes. In the sense of the invention, a storage cell is understood to mean an inherently closed functional unit of the energy storage apparatus which in itself is also able to accept, to store and re-emit electrical energy in particular, if necessary whilst making use of electrochemical processes. A storage cell can for example, but not only, be a galvanic primary or secondary cell (in the context of this invention, primary or secondary cells are termed battery cells without making a distinction and an energy storage apparatus constructed therefrom is termed a battery), a fuel cell, a high performance capacitor, such as a supercap or the like, or an energy storage cell of a different type. In particular, a storage cell constructed as a battery cell for example has an active region or active part, in which electrochemical conversion and storage processes take place, a housing for encapsulating the active part from the surroundings and at least two current contacts which are used as electric poles of the storage cell. The active part for example has an electrode arrangement, which is preferably constructed as a stack or winding with current collecting films, active layers and separator layers. The active and separator layers can be provided at least to some extent as separate film blanks or as coatings of the current collecting films. The current contacts are electrically connected to the current collection films or formed by the same.

A storage cell can also be a cell which accepts and/or emits energy not as electrical, but rather as thermal, potential, kinetic or some other energy type, or a cell which accepts energy in one energy type and re-emits it in a different energy type, wherein the storage can take place in yet another energy type.

In the sense of the invention, clamping is understood to mean securing in a predetermined position, particularly a relative position with respect to one another, by means of clamping forces. During a clamping, elastic and frictional forces can also but not only be utilised. The clamping incidentally does not preclude a positive-fitting positional fixing; it can, but does not have to be limited to a prevention of disintegration.

In the sense of the invention, temperature control is understood to mean a dissipation or supply, particularly dissipation, of heat. It can be realised as a passive cooling, for example by heat radiation at heat radiation surfaces, as an active cooling, for example by means of forced convection at heat exchange surfaces, or by means of heat exchange with an in particular circulating heat transfer agent, such as for example water, oil or the like in a heat exchanger. In this case, a control or regulation can be provided, in order to keep to a predetermined reliable temperature range.

If the clamping device is designed and set up as a functional constituent of the temperature control device, the clamping device can also fulfil functions which are associated with the temperature control of the storage cells or the cell composite. These functions can for example, but not only, comprise the heat transfer from and to the storage cells, the heat dissipation via heat radiation surfaces, the heat transfer from and to a heat transfer agent, heat conduction from and to a heat source or heat sink and/or the like.

To this end, the clamping device is preferably constructed with a heat-conducting material. In the sense of the invention, a material is understood as being heat conducting if it has a thermal conductivity which allows use as a heat conductor in the technical sense. A lower limit can be assumed to be in the range of approximately 10 to 20 W m⁻¹ K⁻¹; this corresponds to the thermal conductivity of high-alloyed steel and a few (preferably fibre-reinforced) plastics provided with filler materials which conduct heat well. It is preferred to select the thermal conductivity in the range of at least 40 to 50 W m⁻¹ K⁻¹, which corresponds to that of spring steel (e.g. 55Cr3). Particularly preferred is a thermal conductivity of at least 100 or a few 100 W m⁻¹ K⁻¹. By way of example, but not only, silicon for example with 148 W m⁻¹ K⁻¹ or aluminium with 221 to 237 W m⁻¹ K⁻¹ or copper with 240 to 400 W m⁻¹ K⁻¹ or silver with approximately 430 W m⁻¹ K⁻¹ are seen as suitable. Carbon nanotubes, the thermal conductivity of which is specified with approximately 6000 W m⁻¹K⁻¹ should constitute the currently achievable optimum with regards to this aspect; the use thereof or of the other special materials is to be considered carefully with regards to the costs, the workability and other technical suitability. Against this background, in the sense of the invention, a construction with a heat-conducting material is to be understood to mean that the clamping device or an element of the clamping device either substantially consists of this material or else, for example for reasons of solidity, electrical insulation, temperature resistance or other properties or purposes, can only have one core, a coating or layer, an envelope or the like made up of such a material. By means of a suitable material combination, the desired properties can thus be set. The same materials as those mentioned above, or else other good heat conductors, such as for example ceramics or diamond, are also considered as filler materials for heat-conducting plastics. (All information about thermal conductivity at 20° C. according to Hütte, Die Grundlagen der Ingenieurwissenschaften, Springer-Verlag, 31st Edition 2000, Engelkraut et al., Wärmeleitfähige Kunststoffe für Entwärmungsaufgaben, Fraunhofer Institut für Integrierte System and Bauelementetechnologie, version of 15.07.2008, Deutsche Edelstahlwerke, data sheet 1.7176, and Wikipedia, article about “Wärmeleitfähigkeit” [Thermal conductivity], version of 22.02.2011; rounding and range summaries, if necessary, the applicant.)

Further preferably, the energy storage apparatus is configured in such a manner that the clamping device preferably bears in a planar manner against heat exchange surfaces of the storage cells at least in certain sections. In the sense of the invention, a heat exchange surface of a storage cell can be understood to mean a surface of the storage cell which can emit heat generated in the interior of the storage cell and if necessary (i.e. in the cold state) can also absorb heat for emission to an interior of the storage cell. It is advantageous if the component which belongs to the heat exchange surface is designed and set up for transmitting heat generated in an active part of the cell to the heat exchange surface. Good thermal coupling is ensured due to the bearing. The thermal coupling can, if necessary, take place by placing a heat-conducting element which can also fulfil tasks of electrical insulation or the like.

Particularly preferably, the energy storage apparatus is configured in such a manner that the storage cells have a prismatic, particularly flat shape and heat exchange surfaces are provided on at least one of the peripheral sides, particularly narrow sides, of the storage cells. In the sense of the invention, a flat prismatic shape is understood to mean a shape, the extent of which in one spatial direction, which is also defined as the thickness direction, is considerably smaller than in other spatial directions, and thus two flat sides with relatively large superficial area can be clearly differentiated from a narrow boundary, particularly at least four peripheral or narrow sides. Flat, prismatic storage cells can be stacked particularly well to form a cell composite, particularly a compact block, they have a good utilisation of space and their contacting can be realised in manifold ways, for example via the flat sides, via the narrow sides, via protruding conductor strips (also termed current contacts) or the like. In the case of stacked prismatic cells, the peripheral sides are located on the outside, so that they are also suitable as heat exchange surfaces. It is to be determined that the invention can nonetheless be applied to not especially flat, but rather for example, but not only to cubic storage cells, likewise to non-prismatic, but rather for example, but not only to cylindrical storage cells.

Further, the energy storage apparatus is preferably configured in such a manner that heat-conducting elements are provided, which are constructed with a heat-conducting material and bear at least in certain sections, preferably planarly, against heat exchange surfaces of the storage cells, wherein the clamping device bears against the heat-conducting elements at least at exposed surfaces. In the sense of the invention, a heat-conducting element is understood to mean a component which is also able to conduct heat from and to storage cells, particularly from and to a space between storage cells within the energy storage apparatus, from and to outside of the space between the storage cells. A heat-conducting element can for example, but not only be a sheet or a moulding made of a heat-conducting material which is arranged between the storage cells. In this case, in the sense of the invention, an exposed surface of a heat-conducting element is to be understood to mean a surface which is accessible from outside of the cell composite, e.g. protrudes at the exposed boundary sides thereof and is there bent for example, but not necessarily, at right angles, in order to bear against the boundary sides of the storage cells. Here also, it is preferred if the storage cells have a prismatic, in particular flat shape; then, the heat exchange surfaces can preferably be provided on flat sides of the storage cells and the exposed surfaces of the heat-conducting elements can preferably be provided in the region of peripheral sides, particularly narrow sides of the storage cells. If the flat sides of the storage cells are constructed as electric poles of the storage cells, the heat-conducting elements can also be constructed with electrically conductive materials and additionally act as electrical contact elements between adjacent storage cells or between a storage cell and a pole connection device of the energy storage apparatus. A heat-conducting element can alternatively have an electrically-insulating property, if an electrical contacting should especially be prevented.

In a preferred configuration of the invention, at least one damping element is provided between two storage cells and/or between a storage cell and another component, which is constructed to be resilient, particularly elastically resilient, at least to some extent, and is constructed in a heat-conducting manner and which is part of a storage cell or part of a heat-conducting element or is attached on surfaces of a storage cell or a heat-conducting element or is arranged between storage cells and a heat-conducting element. In the sense of the invention, a damping element is in particular understood to mean a component which can cushion relative movements between storage cells, if appropriate also between storage cells and other components. Whilst conventional damping elements are usually produced from a material which has a very low thermal conductivity, such as for example PU foam, foam rubber, corrugated cardboard or the like, the damping element according to the present invention is constructed in a thermally conductive manner in this preferred configuration. In this context, one again speaks of a technically usable and constructively intended thermal conductivity, not for example of a minimal and physically unavoidable residual heat conduction, which is also present in inherently heat-insulating materials.

In a preferred configuration of the invention, the clamping device has at least one clamping strap which is constructed with the heat-conducting material and which is preferably constructed at least in certain sections in an inherently resilient, particularly wave-spring-shaped, manner, wherein a plurality of clamping straps are preferably provided, of which at least one clamping strap covers at least one other clamping strap. In the sense of the invention, a clamping strap is understood to mean an elongated, in particular flat, strap-like component which can also be used to clamp an arrangement of storage cells with respect to one another, particularly to clamp the same in an embracing manner. In this case, a closure mechanism, a clamping mechanism or the like can be provided, in order to enable assembly under clamping. It is also possible to achieve the exertion of a uniform clamping force on the cell block by means of an inherently resilient construction. An elastic elongation of the clamping strap can be designed in such a manner that the clamping band is oversized compared to the cell block during assembly under prestress and can be slipped over the same, wherein then, when the prestress is eased off, the clamping strap is positioned securely around the cell block. To this end, the clamping strap can for example be constructed in sections in a wave-spring shaped manner. Particularly advantageously, the sections constructed in a wave-spring shaped manner have planar sections, which under tension bear planarly against heat exchange surfaces of storage cells, heat-conducting elements or the like.

In a further preferred embodiment of the invention, the clamping device has a plurality of tie bolts which are constructed with the heat-conducting material. In the sense of the invention, a tie bolt is understood to mean a rod which is constructed in an elongated manner and in particular protrudes beyond an overall length of the cell stack, which clamps the cell block by means of pressure elements such as plates or flanges in particular, which press in a stack direction of the storage cells onto the respective outer storage cells. Usually, a plurality of tie bolts are provided, for example four, six, eight or more. Such tie bolts for example have a head at one end and a thread at the other end or thread at both ends in order to enable a reliable clamping by means of tightening, by means of screwing in or screwing with the aid of nuts. The use of tie bolts also has the advantage, in the case of a corresponding shaping of the storage cells, that storage cells can be threaded onto the tie bolts in a relatively simple manner before prestressing, which can also simplify the assembly. Tie bolts can for example extend through corresponding recesses of frame elements of frame flat cells and accept heat from the same.

In a further preferred embodiment, the clamping device has holding elements and clamping elements, wherein the holding elements are arranged alternately with the storage cells in order to hold the storage cells between them, and wherein the clamping elements clamp the holding elements with the storage cells, wherein the holding elements are thermally coupled at least in certain sections to heat exchange surfaces of the storage cells, and wherein the clamping elements bear at least in certain sections against heat exchange surfaces of the holding elements. In this case, it is advantageous if the holding elements are constructed with a heat-conducting material at least between the contact surfaces with the storage cells and the contact surfaces with the clamping elements. In this manner, a reliable clamping of the holding elements and the storage cells to form a battery block can also be provided. Heat exchange surfaces of the holding elements can be external surfaces, particularly boundary surfaces, of the holding elements, for example but not only if clamping straps are provided as clamping elements. Clamping elements, such as for example but not only tie bolts can also be guided through ducts, for example holes, in the holding elements; in this case, heat exchange surfaces of the holding elements can be formed by inner surfaces of the ducts. Heat exchange surfaces of the storage cells can be provided by flat or boundary sides of the storage cells, by current contacts or at passage regions of current contacts through a housing of the storage cells.

Further preferably, the energy storage apparatus is configured in such a manner that the clamping device is thermally coupled at least in certain sections, particularly by means of planar contact, with sections of a heat exchanger device, wherein the heat exchanger device is preferably attached to a heat transfer agent circuit and wherein the heat transfer agent circuit can preferably be controlled or regulated. In this manner, the clamping device can transport heat accepted from the storage cells to the heat exchanger device and there emit the same to a heat transfer agent, such as for example but not only water or oil. The heated heat transfer agent can circulate through the heat transfer agent circuit and emit the absorbed heat again at a different location, for example to an air cooler or the like.

Particularly preferably, the heat exchanger device fits closely with heat exchange surfaces of the storage cells at least in certain sections, wherein the storage cells have a flat prismatic shape and heat exchange surfaces are provided on at least two, preferably opposite narrow sides of the storage cells. Thus, the storage cells can on the one hand emit heat to the heat exchanger device by means of direct contact, and on the other hand can emit heat to the clamping device at locations which are not in contact with the heat exchanger device. Preferably, in the process, the clamping device clamps the cells both together and to the heat exchanger device.

According to a further aspect of the invention, an energy storage cell is suggested, with an active part and a housing surrounding the active part, and also with heat-conducting means, wherein the heat-conducting means are designed and set up to conduct heat from at least one warmer surface of the energy storage cell during operation of the energy storage cell to at least two cooler surfaces of the energy storage cell during operation of the energy storage cell. If a plurality of such energy storage cells are assembled to form a block, it is possible to emit heat to both cooler surfaces by means of direct contact with a clamping device, for example a clamping strap, or to a clamping strap on one side and to a heat exchanger on the other side. An energy storage cell of this type is therefore particularly suitable for use in an energy storage apparatus, as has previously been described.

Furthermore, in the case of such an energy storage cell, the heat profile of the energy storage cell can also be balanced without explicit cooling.

In a preferred embodiment, the energy storage cell is provided with a prismatic, electrically insulating frame part and two flat, electrically conductive side parts, wherein the frame part and the side parts construct the housing, wherein current contact lugs of the active part are connected to at least one of the side parts in each case, so that the side parts construct electrical poles of the energy storage cell, which are electrically insulated from one another by means of the frame part, and wherein at least two, preferably opposite narrow sides of the frame part are covered at least in certain sections by means of angled sections of at least one of the side parts.

According to a further aspect of the invention, a heat-conducting element is suggested, with a thin-walled structure, particularly for accommodating an energy storage cell, wherein the thin-walled structure outlines a shape of a preferably flat cuboid, and wherein the thin-walled structure has at least one flat side and at least two narrow sides adjoining the flat side. If an energy storage cell, particularly a flat cell, for example but not only a frame flat cell, is accommodated in such a heat-conducting element, the at least one flat side of the thin-walled structure of the heat-conducting element absorbs heat from one active part of the cell adjoining the flat side and conduct it to the at least two narrow sides. If a plurality of energy storage cells with such a heat-conducting element are assembled to form a block, it is possible to emit heat to the narrow sides by means of direct contact with a clamping device, for example a clamping strap, or to a clamping strap on one side and to a heat exchanger on the other side. A heat-conducting element of this type is therefore particularly suitable for use in an energy storage apparatus, as has previously been described. If the flat sides of the energy storage cell form electrical poles, it is advantageous if the heat-conducting element is constructed from a conductor material, wherein a short circuit between the opposite poles of the energy storage cell is to be prevented by means of suitable measures.

In a preferred embodiment, at least one narrow side can be produced by bending a tab adjoining the flat side after accommodating an energy storage cell, wherein a structure surrounding the energy storage cell at least substantially on all sides preferably results.

An energy storage apparatus according to the invention, an energy storage cell according to the invention and a heat-conducting element according to the invention are in particular provided for use in a motor vehicle, wherein the motor vehicle is a hybrid vehicle or an electric vehicle in particular.

The previous and further features, objects and advantages of the present invention become clearer from the following description, which has been completed with reference to the attached drawings.

In the drawings:

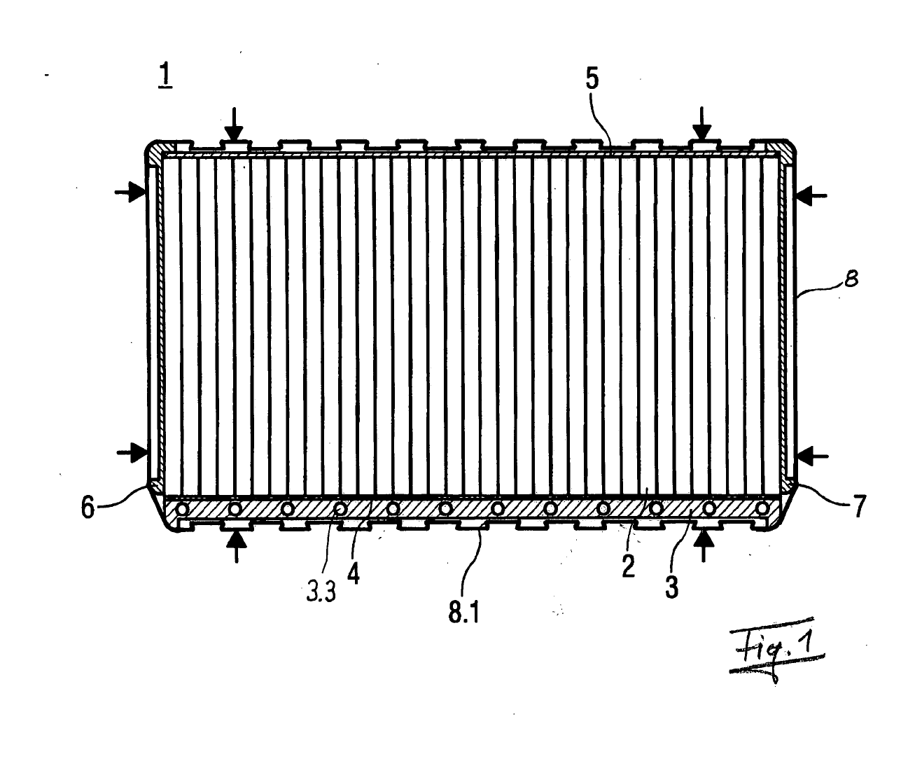

FIG. 1 shows a resiliently clamped cell block made up of a plurality of frame flat cells in a schematic cross-sectional view;

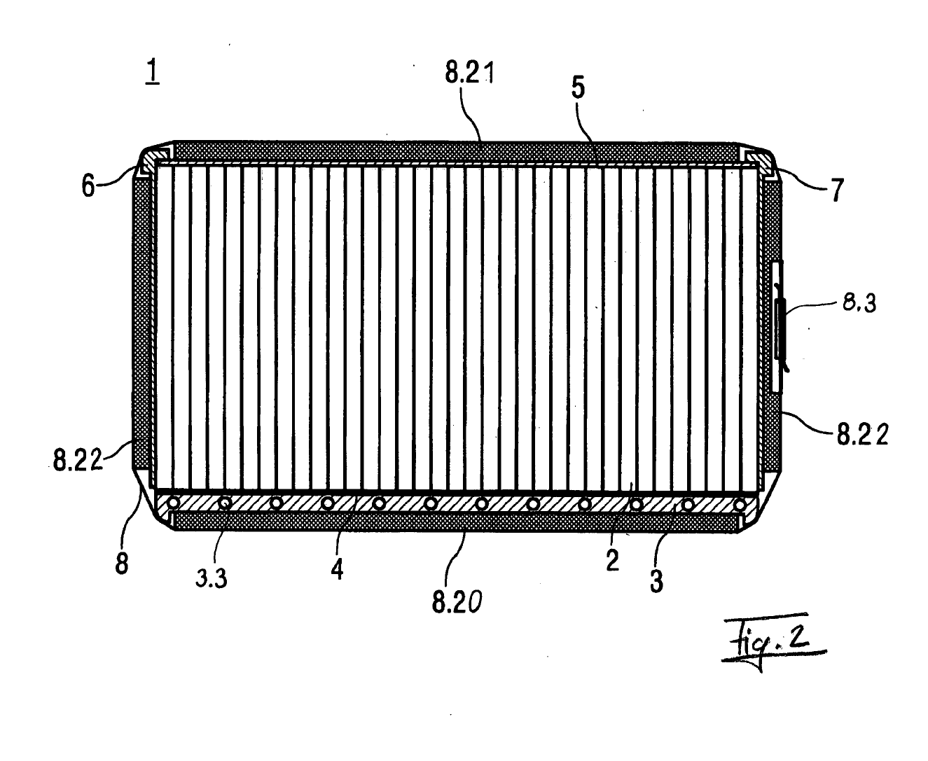

FIG. 2 shows a battery with cells constructed as frame flat cells, in which an elastic element is inserted between a clamping device surrounding the cell block and the cell block, in a schematic cross-sectional view;

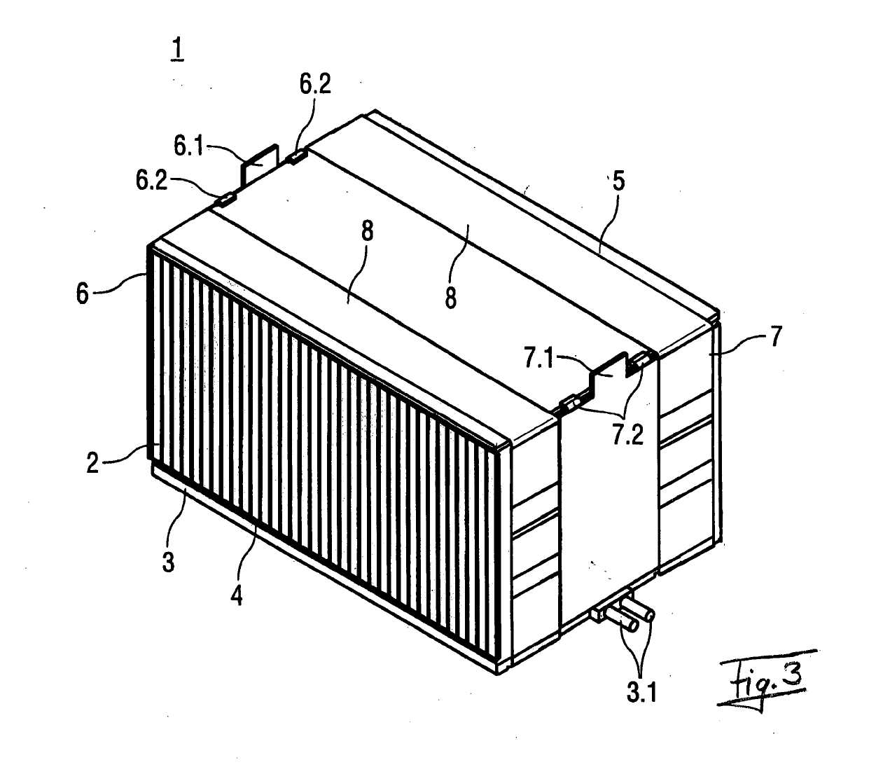

FIG. 3 shows a battery with a clamped cell block made up of a plurality of frame flat cells in a schematic spatial view;

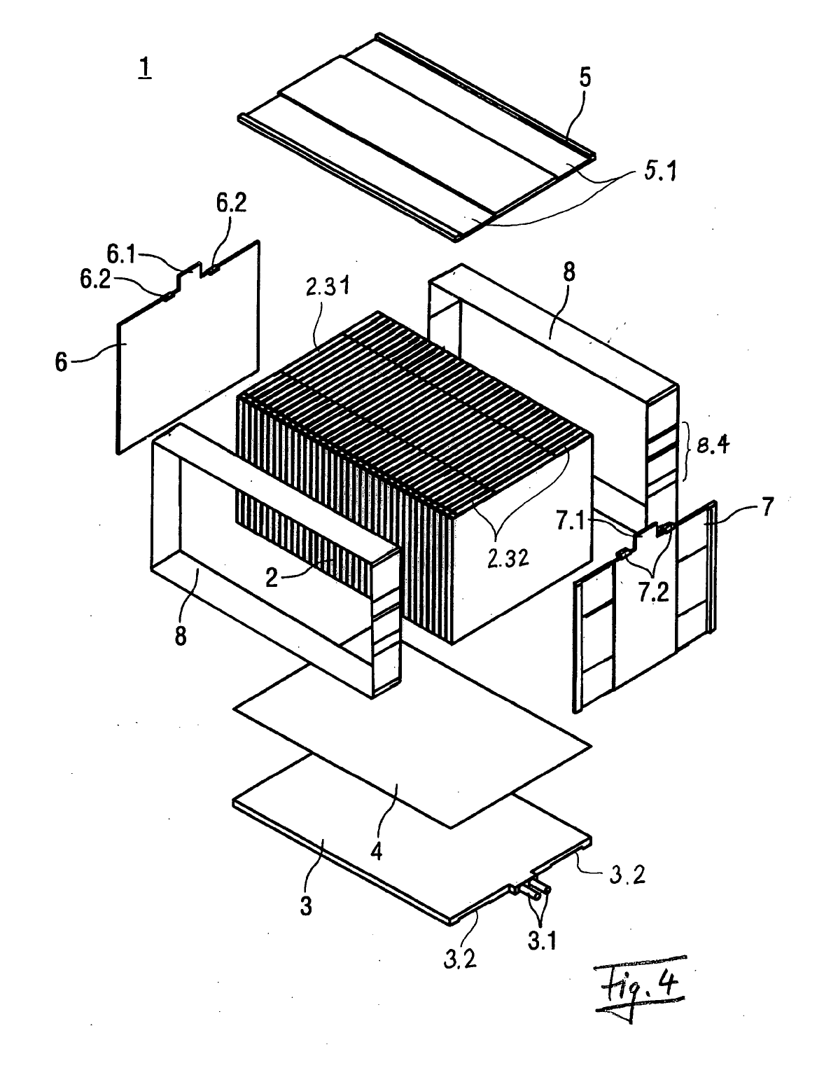

FIG. 4 shows an exploded illustration of the battery from FIG. 3 in a schematic spatial view;

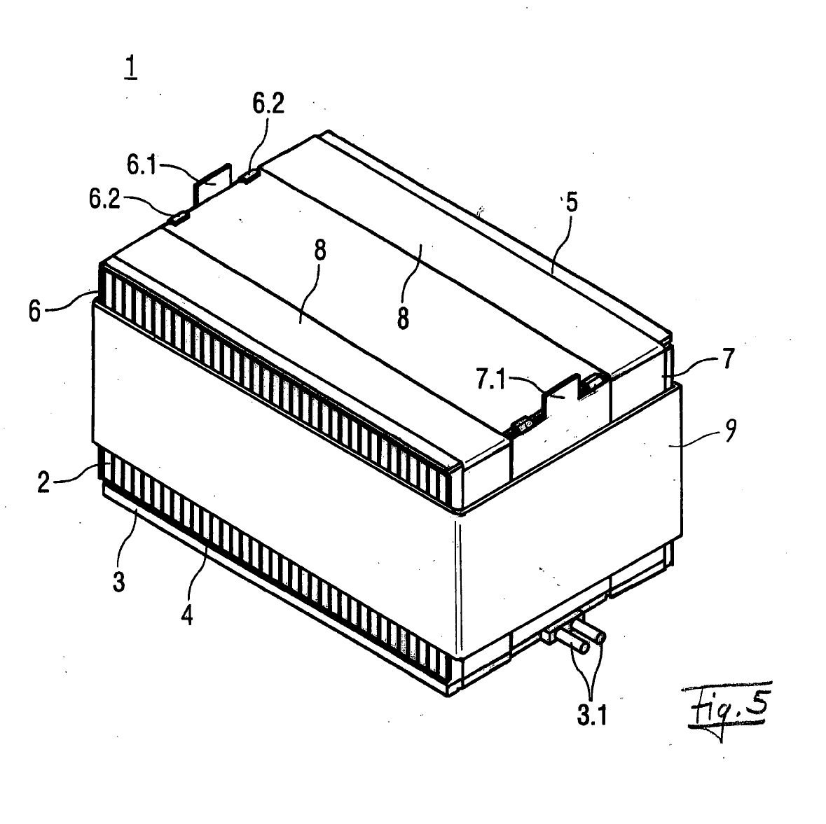

FIG. 5 shows a battery with a cell block made up of a plurality of frame flat cells clamped in three spatial directions in a schematic spatial view;

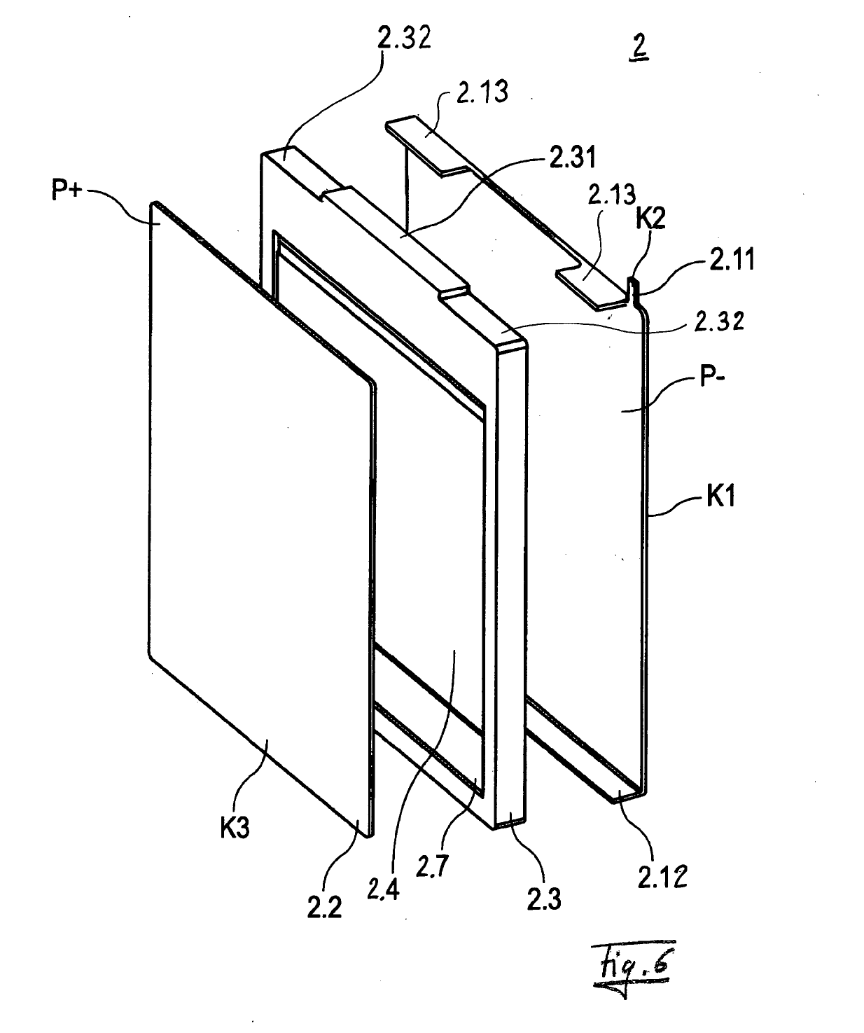

FIG. 6 shows an exploded illustration of a frame flat cell in a schematic spatial view;

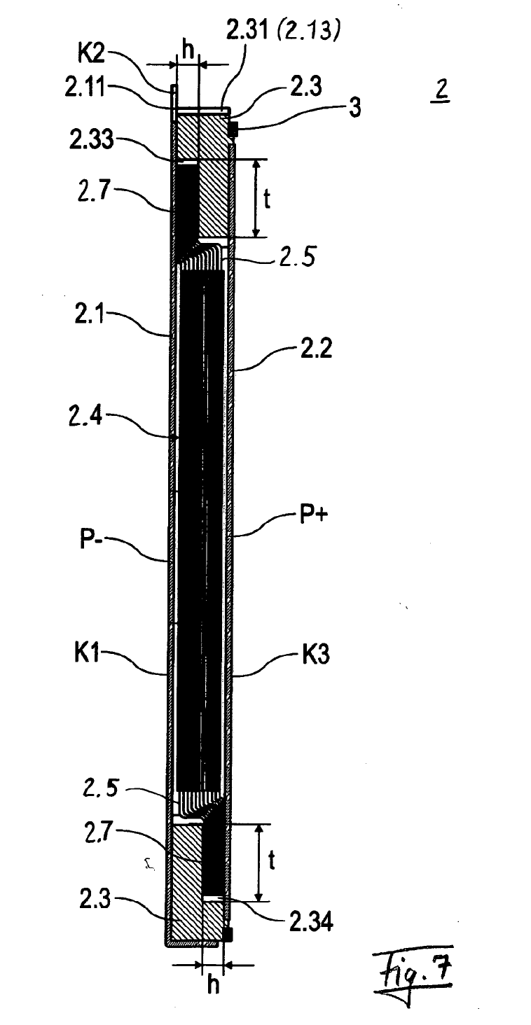

FIG. 7 shows a schematic cross-sectional illustration of an assembled cell according to FIG. 6;

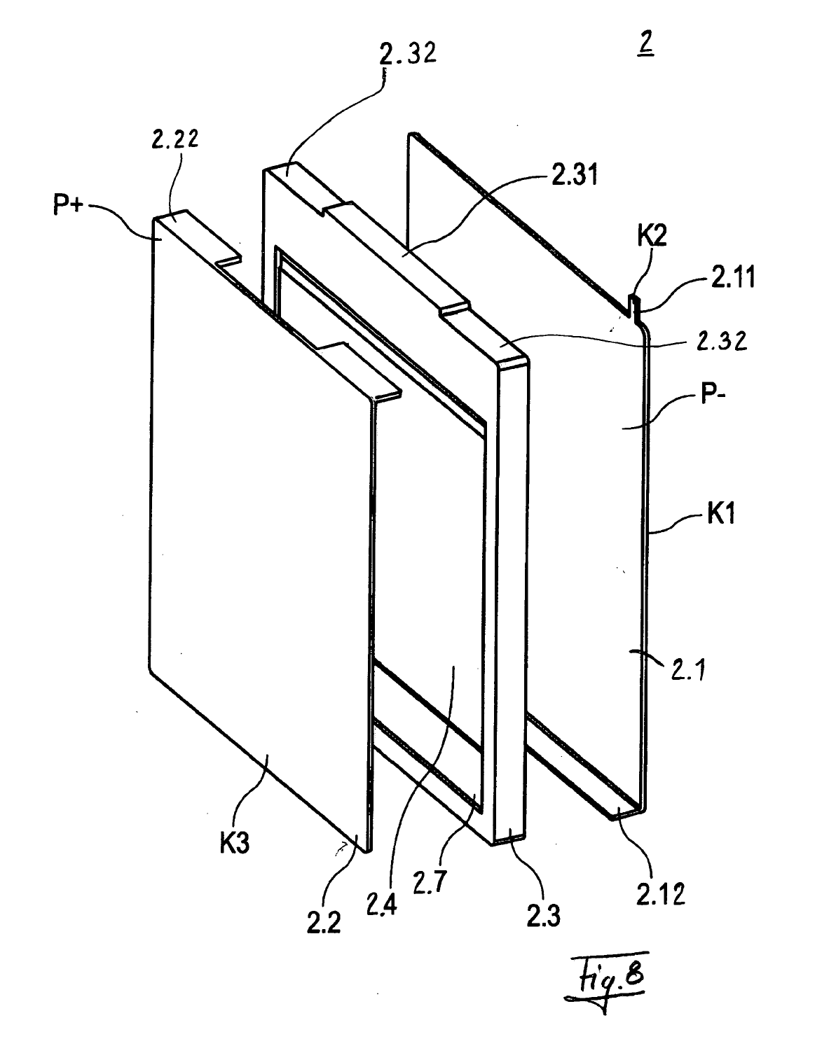

FIG. 8 shows an exploded illustration of a frame flat cell in a schematic spatial view;

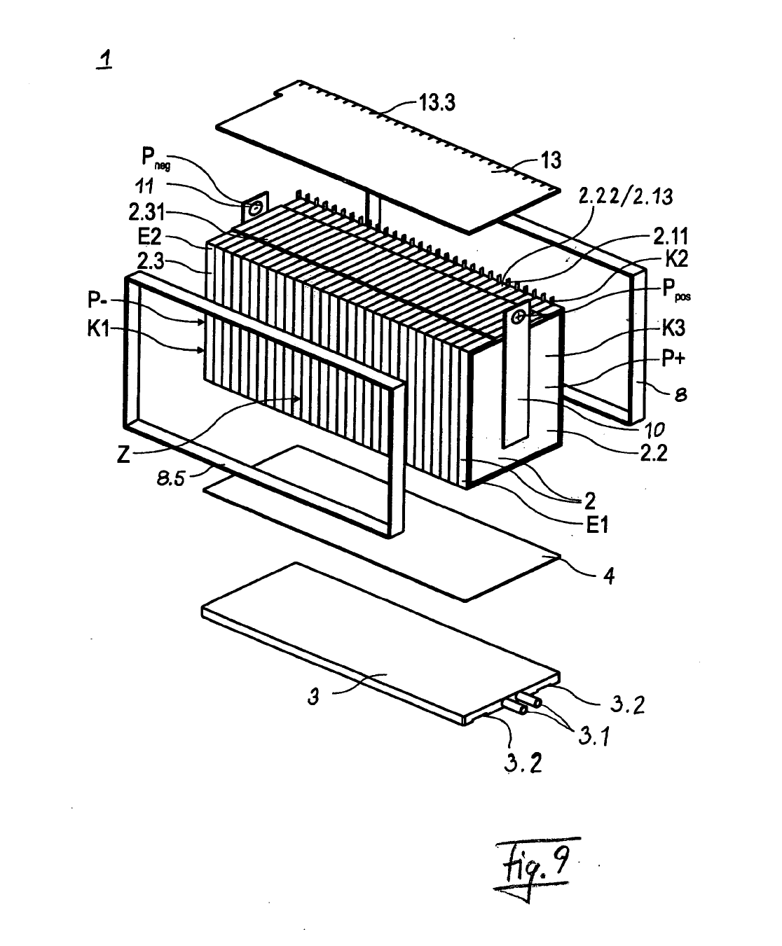

FIG. 9 shows an exploded illustration of a further battery in a schematic spatial view;

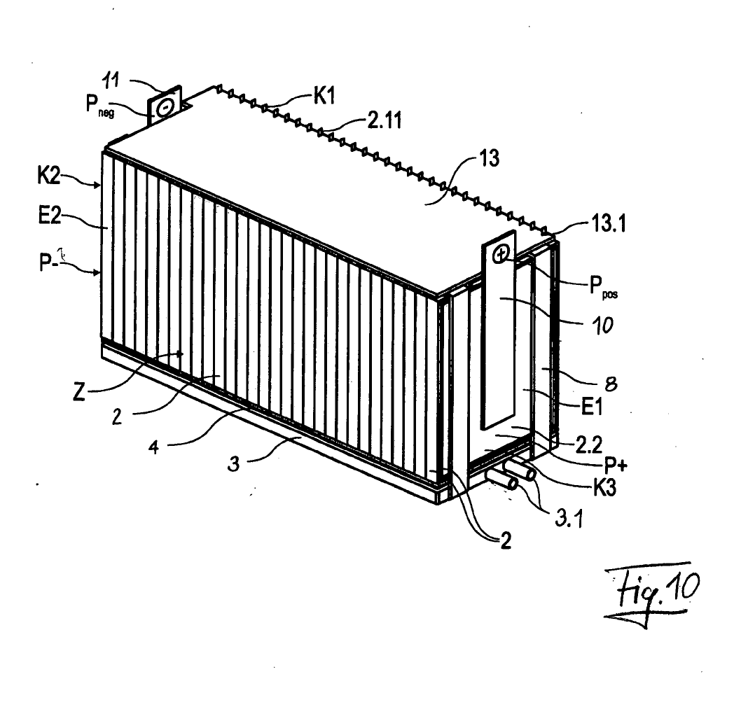

FIG. 10 shows a schematic spatial view of the battery according to FIG. 9 in an assembled state;

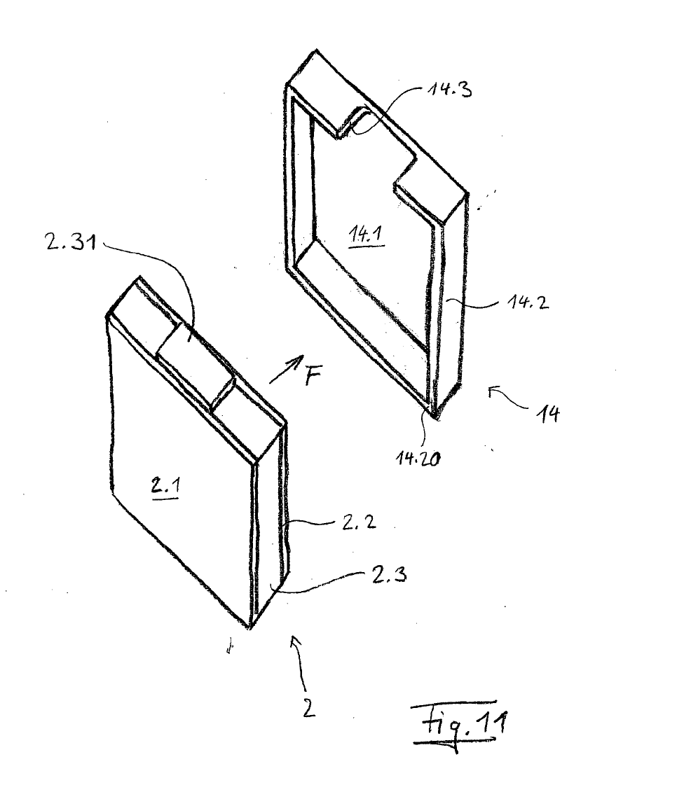

FIG. 11 shows a frame flat cell and a heat-conducting element in a schematic spatial illustration;

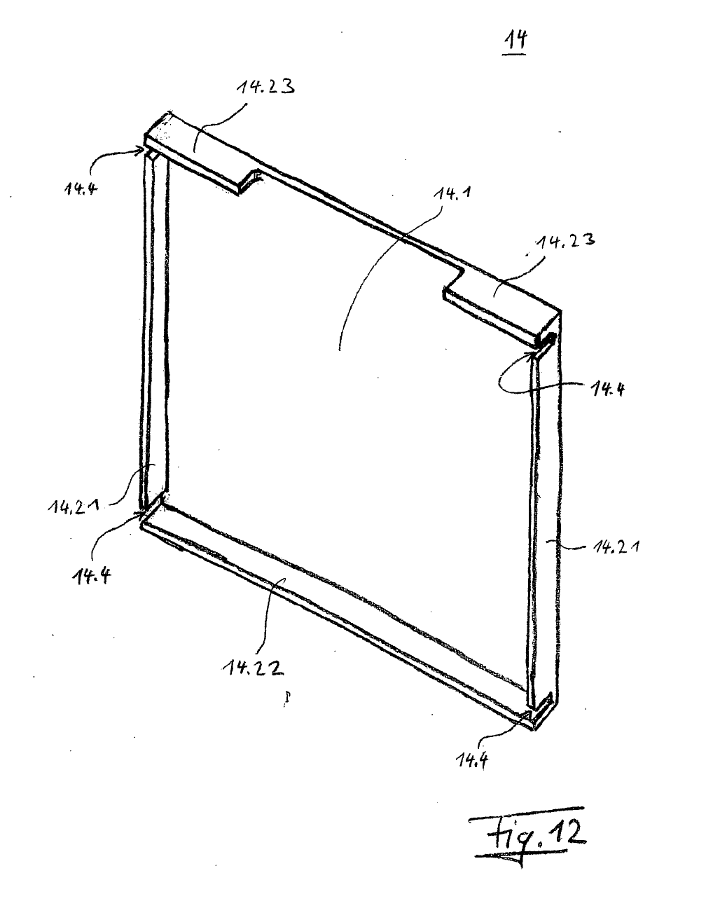

FIG. 12 shows a similar heat-conducting element in a schematic spatial illustration;

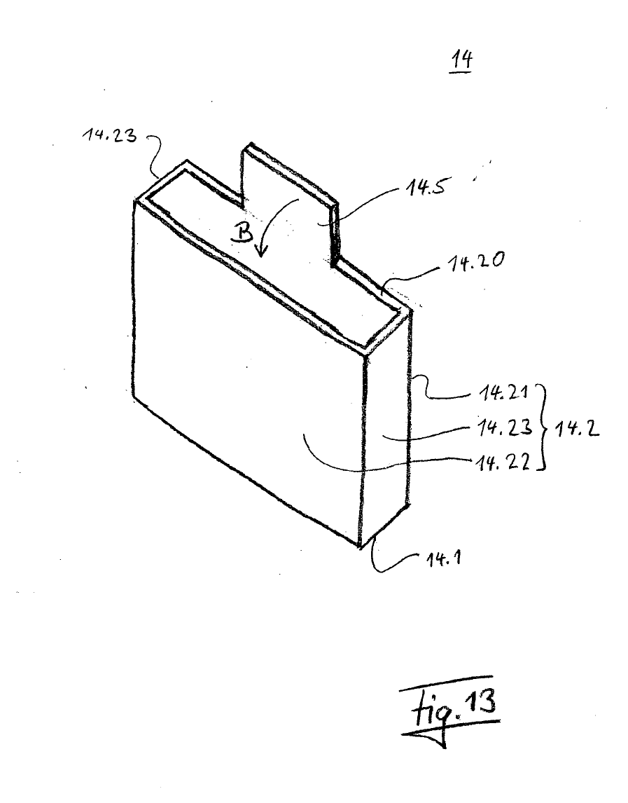

FIG. 13 shows a different heat-conducting element in a schematic spatial illustration;

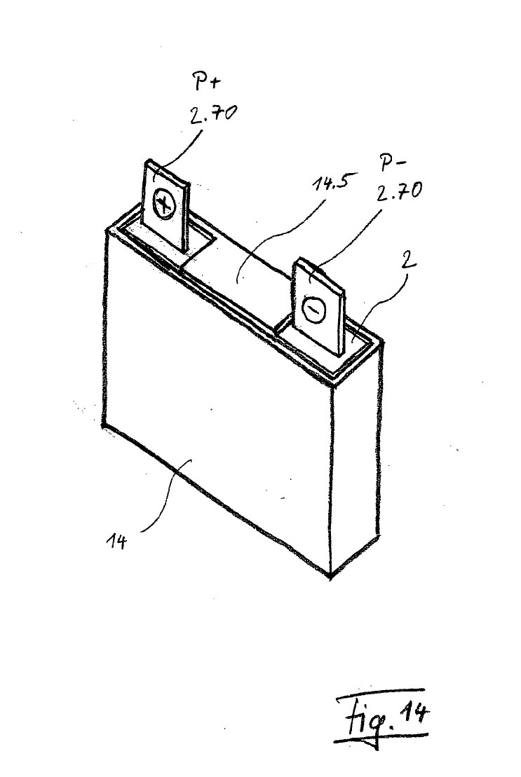

FIG. 14 shows a heat-conducting element according to FIG. 13 with a battery cell in a schematic spatial illustration;

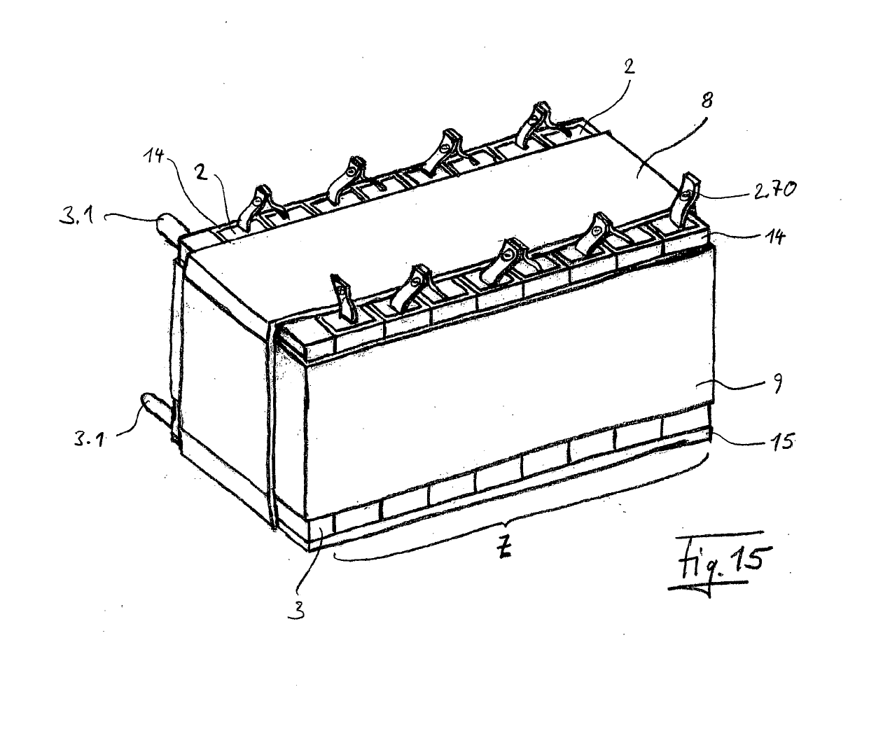

FIG. 15 shows a battery with a plurality of battery cells and heat-conducting elements according to FIG. 14, which are clamped with a base plate and an end-face cooling plate, in a schematic spatial view;

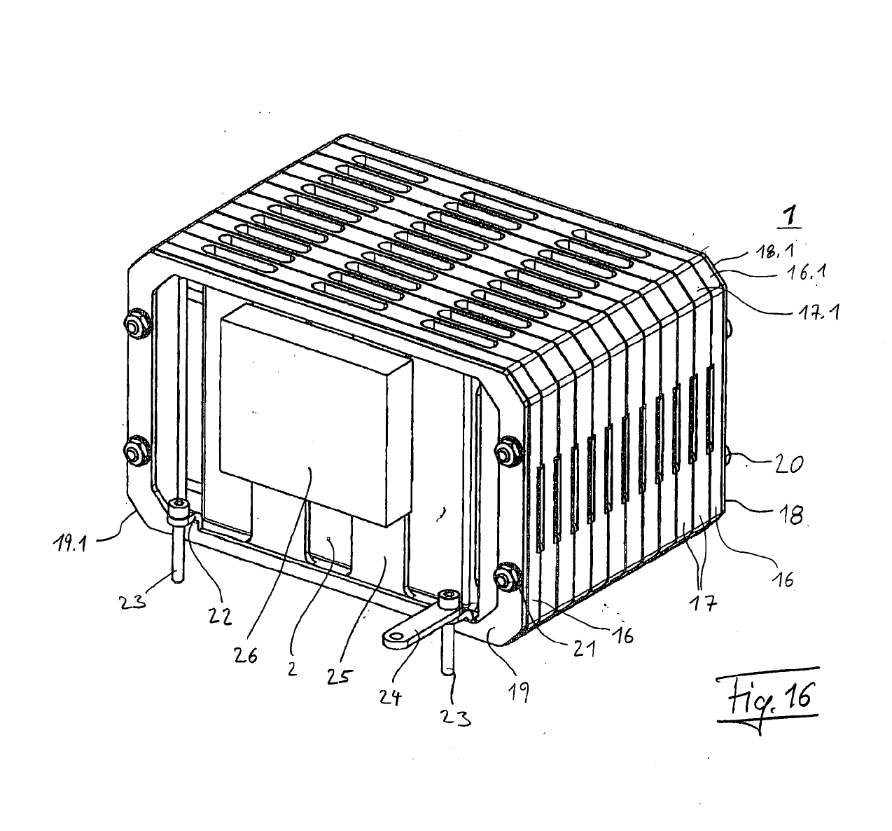

FIG. 16 shows a battery with a plurality of pouch cells which are clamped by means of tie bolts between frame elements;

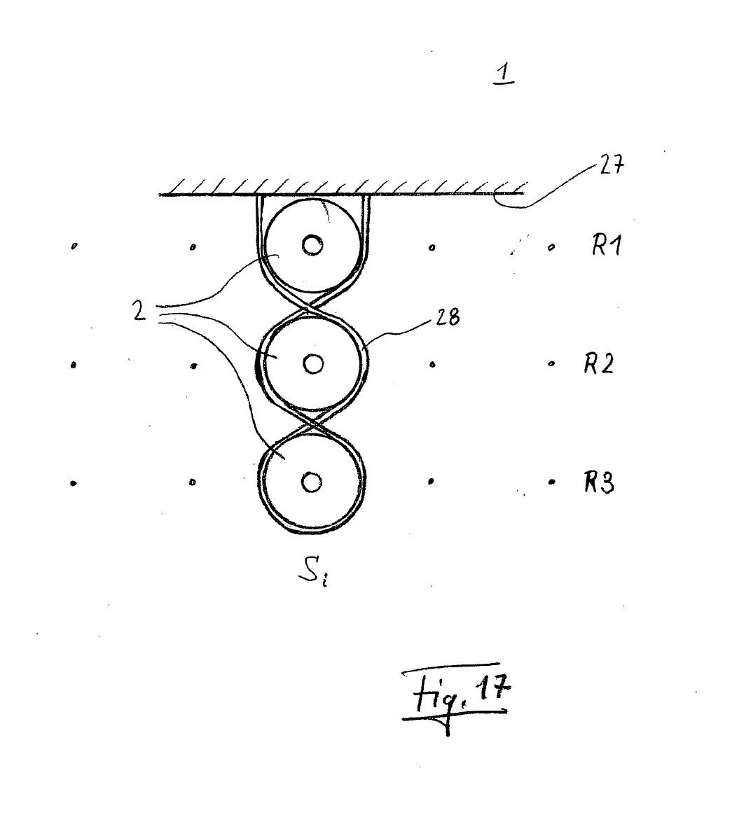

FIG. 17 shows a battery with a plurality of rows of cylindrical battery cells, which are clamped by means of a fixing strap to a battery housing wall, in a schematic plan view;

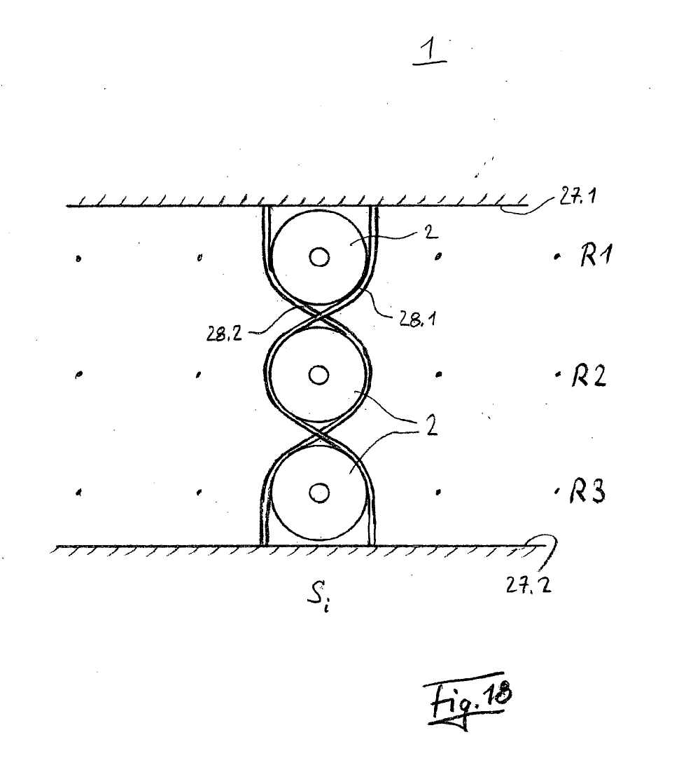

FIG. 18 shows a battery with a plurality of rows of cylindrical battery cells, which are clamped by means of fixing straps between two battery housing walls, in a schematic plan view;

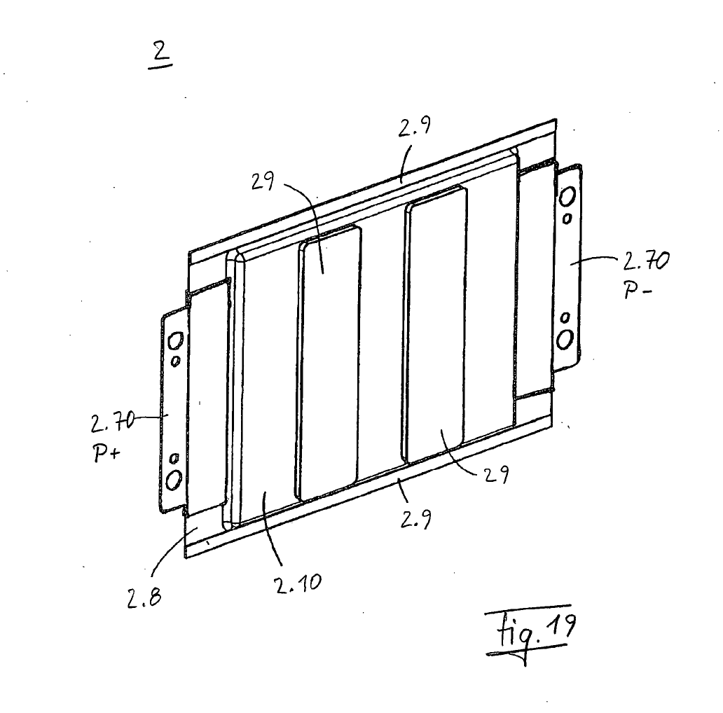

FIG. 19 shows a pouch cell with elastic elements in a schematic spatial view;

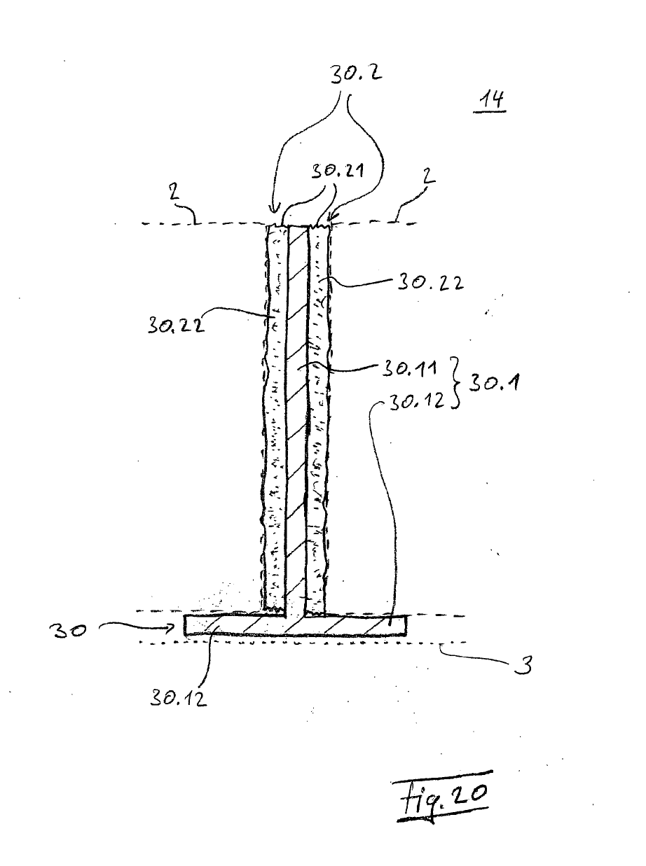

FIG. 20 shows a heat-conducting element with elastic layers in a schematic cross-sectional view.

It is to be pointed out that the illustrations in the figures are schematic and are at least substantially limited to the reproduction of features which are helpful for the understanding of the invention. It is also to be pointed out that the dimensions and size ratios reproduced in the figures are essentially based on the clarity of the illustration and are not necessarily to be understood as limiting unless something else should emerge from the description.

FIG. 1 shows a battery 1 in a schematic (part) sectional illustration with a plurality of galvanic cells 2 forming a cell composite as an exemplary embodiment of the present invention. The cells 2 are illustrated unsectioned in FIG. 1.

The galvanic cells 2 are secondary cells (accumulator cells) with active regions which contain lithium. Galvanic cells of this type, which are known as lithium ion cells or the like, are fundamentally known in their structure. In the context of this application, the galvanic cells 2 are termed cells 2 for the sake of simplicity. In this exemplary embodiment, the cells 2 are constructed as so-called frame flat cells with a narrow, essentially cuboidal cell housing. The cells 2 are arranged plane-parallel one behind the other and can be connected in parallel and/or in series with one another, depending on the application.

A cooling plate 3 for controlling the temperature of the cells 2 is arranged below the cells 2. The cooling plate 3 has a cooling channel 3.3, through which a coolant can flow and sectioned a number of times in the Figure, in its interior. Arranged between the cooling plate 3 and the base surfaces of the cells 2 is a heat-conducting film 4 made up of electrically insulating material, which electrically insulates the cooling plate 3 from the cells 2. Arranged above the cells 2 is a pressure plate 5 made up of an electrically insulating material with good heat conducting properties, such as for example a reinforced plastic with heat conducting doping. Alternatively, the pressure plate 5 can be produced from a metal, such as for example steel, aluminium or the like, wherein an electrically insulating coating or an electrically insulating intermediate layer similar to the heat-conducting film 4 is provided in the region of resting on the upper narrow sides of the cells 2.

Located at a front end of the cell composite is a front pole plate 6, and a rear pole plate 7 is arranged at a rear end of the cell composite. The pole plates 6 and 7 in each case form a pole of the battery 1 and in each case have a lug-like elongation (cf. 6.1, 7.1 in FIG. 3 described in more detail further below) protruding beyond the pressure plate 5 in each case, which in each case forms a pole contact of the battery 1.

Further, the pole plates 6 and 7 in each case have two fixing noses (cf. 6.2, 7.2 in FIG. 3), which are angled parallel to the pressure plate 5 of the respective pole plate 6, 7 and bear against the pressure plate 5. The pressure plate 5, the cells 2, and the cooling plate 3 are pressed against one another by means of two clamping straps 8 (only one can be seen in FIG. 1), which are in each case guided around the pressure plate 5, the pole plates 6, 7 and the cooling plate 3. In the present exemplary embodiment, the clamping elements 8 are constructed as inherently elastic clamping straps 8, wherein the inherent elasticity is essentially set by means of spring zones 8.1. The spring zones 8.1 are realised by means of a wave-like shaping of the clamping straps 8. The spring zones 8.1 are in this case preferably constructed where the clamping straps 8 do not run over edges of the pole plates 6, 7 or the cooling plate 3, particularly on the upper and underside of the battery 1. The wave shape thereof has at least somewhat at least essentially planar sections for a large contact surface at least in the region of the bearing of the wave troughs on the cooling plate 3 and the pressure plate 5. The introduction of the forces into the cell block 1 takes place in the axial direction via the front pole plate 6 and the rear pole plate 7. In the direction perpendicular thereto, the force is introduced below via the cooling plate 3 and above via the pressure plate 5. To prevent a short circuit, the pole plates 6, 7 are further at least provided with an electrically insulating coating or an electrically insulating intermediate layer similar to the heat-conducting film 4 where the clamping bands 8 bear. (Although not illustrated in any more detail in the figure, the clamping bands can also have elastic sections in the region of the pole plates 6, 7.)

The clamping bands 8 are constructed from a good heat conductor, such as for example spring steel and have heat-conducting contact with the pressure plate 5 and the cooling plate 3 in the region of the wave troughs of the spring zones 8.1.

An electrically insulating coating of the clamping bands 8 or an insulating intermediate layer is provided at least in the region of the pole plates. In a design variant, the clamping straps can be produced from a non-conducting material, for example from a heat conducting plastic, preferably with a glass fibre, kevlar or metal reinforcement and a heat-conducting filler material. In such a case, an additional insulation under is not required under certain circumstances.

Due to the heat-conducting properties of the clamping strap 8 and the pressure plate 5 and the heat-conducting contact of the pressure plate 5 with the cell upper sides and the clamping strap 8, on the one hand, heat compensation between the cells 2 in the upper region of the battery also and also heat transport from the upper side to the cooling plate 3 located on the underside can take place.

A further exemplary embodiment of the present invention is shown in FIG. 2 in an illustration according to FIG. 1, in which heat-conducting elements 8.20, 8.21, 8.22 are provided between a clamping strap 8 surrounding a cell block and the cell block.

According to the illustration in FIG. 2, a lower heat-conducting element 8.20 is provided between the clamping strap 8 and the cooling plate 3, an upper heat-conducting element 8.21 is provided between the clamping strap 8 and the pressure plate 5 and end-face heat-conducting elements 8.22 are provided between the clamping strap 8 and the pole plates 6, 7. Rigid metal blocks, for example aluminium blocks, can be used as heat-conducting elements 8.20, 8.21, 8.22. The clamping strap surrounds the cell block and ensures a uniform pressing force in the axial direction and also in the direction of the vertical axis. The clamping strap 8 is closed by means of a crimp closure 8.3; this ensures a secure clamping of the battery 1.

In a design variant, the heat-conducting elements 8.20, 8.21, 8.22 can have elastic properties and e.g. be configured as corrugated sheet springs, cushions filled with metal filings, metal-doped foam materials, cushions or mats with a heat-conducting gel or the like.

In contrast with the exemplary embodiment illustrated in FIG. 1, the clamping strap 8 is constructed in a straight manner, i.e. without elastic corrugation, and bears by means of its full surface on the heat-conducting elements 8.20, 8.21, 8.22.

FIGS. 3 and 4 show a further design variant of a battery 1 according to FIG. 1 or FIG. 2 in schematised spatial views. In this case, FIG. 3 shows an assembly state of the battery and FIG. 4 shows the battery 1 in an exploded illustration.

The cooling plate 3 has a cooling channel (3.3 in FIGS. 1 and 2) in its interior, through which a coolant can flow, and also two coolant connections 3.1 for supplying and draining the coolant. The cooling plate 3 can be connected via the coolant connections 3.1 to a coolant circuit which is not illustrated, by means of which coolant circuit the waste heat absorbed by the coolant can be dissipated from the battery 1.

In this design variant, the clamping device is realised by means of two clamping straps 8, which are provided with an electrically insulating, but heat conducting layer. The clamping straps 8 have a clamping region 8.4 which is constructed as a wave-like expansion region in the design variant illustrated. Instead of an expansion region, a crimping method can also be applied, in order to tension the clamping straps and securely connect the ends to one another. In a further alternative, toggle closures, screw closures or a comparable type of turnbuckle can be provided. Although in the figure, a clamping region 8.4 is only to be seen on the side of the rear pole plate 7, such clamping regions can also be provided on the side of the front pole plate 6.

The clamping straps 8 run in depressions 5.1 over the pressure plate 5, in depressions 7.3 over the rear pole plate 7, in depressions 3.2 over the cooling plate 3 and in depressions, which are not illustrated in any more detail, over the front pole plate 6.

FIG. 5 shows a further design variant of the battery 1 according to FIG. 3 in a schematised spatial view.

In addition to the vertically running clamping straps 8, a further clamping strap 9 is provided, which surrounds the battery 1 horizontally. It runs in depressions, which are not illustrated in any more detail, in the lateral narrow sides of the cells 2 and the front and rear pole plates 6, 7 and covers the clamping bands 8 in the region of the pole plates 6, 7. In an alternative realisation, the clamping straps 8 can cover the clamping strap 9.

In a further variant, pressure plates (not illustrated in any more detail) can also be provided between the clamping strap 9 and the lateral narrow sides of the cells 2.

In all design variants, in the case of electrically conductive clamping elements, electrical contact of the same with the pole plates 6, 7 is to be prevented by means of suitable means, as described previously.

In a design variant, the pressure plate 5 is constructed at least to some extent from an electrically insulating support material, preferably from plastic with an optional glass fibre reinforcement in one embodiment and supports electrical components for monitoring and/or controlling the battery functions and also conductor tracks, which are not illustrated in each case. Electrical components of this type are for example cell voltage monitoring elements and/or cell voltage compensation elements for compensating different charge levels of cells, which are present for example on the printed circuit board in the form of microchips, and/or temperature sensors for monitoring a temperature of the cells 2. At least in regions against which the clamping straps 8 or heat-conducting elements 8.21 bear, the pressure plate 5 has good heat conduction properties; zones of this type can also be termed heat conduction zones. The pressure plate 5 is in this case preferably further constructed in such a manner that heat producing and/or heat sensitive circuit elements can be arranged in the vicinity of the of the heat-conducting zone and/or in heat-conducting contact with the heat-conducting zone. Particularly preferably, the printed circuit board itself has good heat conduction properties and forms the pressure plate 5 as such. In a further design variant, the pressure plate 5 can be constructed completely from a material with good heat conduction properties, wherein a printed circuit board as described previously is provided in regions against which no clamping straps 8 or heat-conducting elements 8.21 bear.

FIG. 6 shows a galvanic cell 2 constructed as a flat cell as a further exemplary embodiment of the present invention in a schematised spatial exploded illustration.

According to the illustration in FIG. 6, a cell housing (a housing) of the cell 2 is formed from two cell housing side walls 2.1, 2.2 and a cell housing frame 2.3 arranged therebetween, which runs around the boundary. The cell housing side walls 2.1, 2.2 of the cell 2 are electrically conductively realised and form poles P+, P− of the cell 2. The cell housing frame 2.3 is realised in an electrically insulating manner, so that the cell housing side walls 2.1, 2.2 of different polarity are electrically insulated from one another. The cell housing frame 2.3 additionally has a partial material elevation 2.31 on an upper side, the function of which is explained in more detail in the description of FIGS. 9 and 10.

The cell 2 has at least three voltage connection contacts K1 to K3. Namely, the cell housing side wall 2.1 forming the pole P− has at least two voltage connection contacts K1, K2 which are electrically connected to one another, connected in parallel in particular, inside the cell in particular. In this case, the first voltage connection contact K1 is formed by the pole P− of the cell 2 and thus the cell housing side wall 2.1. The second voltage connection contact K2 is realised as a measuring connection 2.11, which protrudes radially above the cell housing side wall 2.1 at any desired position above the cell 2 as a lug-like extension.

In the present exemplary embodiment of the invention, the cell housing side wall 2.1 with the lug-like measuring connection 2.11 also has a lower edge 2.12 bent through 90° in the direction of the cell housing frame 2.3 in a lower region, so that in the case of use of a heat-conducting plate 8 illustrated in FIGS. 9 and 10, an enlargement of an effective heat transfer surface and thus an improved cooling of the battery 1 are achieved. Further, the cell housing side wall 2.1 with the lug-like measuring connection 2.11 has tabs 2.13 bent through 90° in the direction of the cell housing frame 2.3 in an upper region. In assembly, the tabs 2.13 grip next to the material elevation 2.31 onto the upper narrow side 2.32 of the cell housing frame 2.3, whilst the edge 2.12 grips onto the lower narrow side of the cell housing frame 2.3.

A battery 1 illustrated in more detail in FIGS. 9 and 10 consists of a plurality of such cells 1, the poles P+, P− of which, particularly the cell housing side walls 2.1, 2.2 realised as flat sides, are connected to one another in parallel and/or in series and form a cell composite Z illustrated in 5 to 7 as a function of a desired battery voltage and power.

Initially, however, the inner structure of the cell 2 is explained on the basis of a sectional illustration in FIG. 7.

According to the illustration in FIG. 7, within the housing constructed by means of the previously described housing parts 2.1, 2.2, 2.3, an active region 2.4 which is not described in any more detail is provided, in which electrode films 2.5 of different polarity, particularly aluminium and/or copper films and/or films made of another metal alloy, which are coated with electrochemically active materials, are stacked one above the other and electrically insulated from one another by means of a separator, particularly a separator film.

In a boundary region of the electrode films 2.5 protruding over the central region of the electrode stack 2.4, electrode films 2.5 of the same polarity are electrically connected to one another. The ends of the electrode films 2.5 of the same time polarity which are connected to one another thus form a pole contact 2.7, which is also termed a current contact lug. The pole contacts 2.7 of different polarity of the cell 2 are also termed current contact lugs 2.7 in the following for better clarity. In detail, the ends of the electrode films 2.5 are electrically conductively compression moulded and/or welded to one another and form the current contact lugs 2.7 of the electrode stack 2.4.

The electrode stack 2.4 is arranged in the cell housing frame 2.3 running around the boundary of the electrode stack 2.4. The cell housing frame 2.3 has to this end two mutually spaced material recesses 2.33, 2.34 which are constructed in such a manner that the current contact lugs 2.7 of different polarity are arranged in the material recesses 2.33, 2.34. The clearance h of the material recesses 2.33, 2.34 is constructed in such a manner that it corresponds to the extent of the current contact lugs 7 stacked one above the other in an uninfluenced manner or is lower than the same. The depth t of the material recesses 2.33, 2.34 corresponds to the extent of the current contact lugs 7 or is constructed larger than the same.

As the cell housing frame 2.3 is preferably produced from an electrically insulating material, the current contact lugs 7 of different polarity are electrically insulated from one another, so that additional arrangements for an electrical insulation are advantageously not necessary.

In the case of fixing the cell housing side walls 2.1, 2.2, which for example takes place in a manner which is not illustrated in any more detail by means of adhesive bonding and/or flanging the flat sides into a recess running around in the cell housing frame 2.3, the current contact lugs 2.7 of different polarity are pressed against the cell housing side walls 2.1, 2.2, so that a respective electric potential of the current contact lugs 2.7 is present at the cell housing side walls 2.1, 2.2 and these form the poles P+, P− of the cell 2.

In a design variant, a film, which is not illustrated in any more detail and e.g. is produced from nickel, is additionally arranged between the current contact lugs 2.7, which e.g. are produced from copper, and the housing side walls 2.1, 2.2, which e.g. are produced from aluminium, in order to achieve an improved electrical connection between the current contact lugs 2.7 and the cell housing side walls 2.1, 2.2.

In further design variants, an electrically insulating film, which is not illustrated in any more detail, is arranged between the current contact lugs 2.7 and the cell housing side walls 2.1, 2.2 or the cell housing side walls 2.1, 2.2 are realised with an electrically insulating layer on one side, so that an electrical contacting of the current contact lugs 2.7 with the cell housing side walls 2.1, 2.2 only arises during a full penetration welding method from outside through the cell housing side walls 2.1, 2.2, which is not described in any more detail and is known from the prior art.

FIG. 8 shows a design variant of the cell 2 illustrated in FIGS. 6 and 7 in a schematised spatial exploded illustration.

As in FIG. 6, the cell housing side wall 2.1 with the lug-like measuring connection 2.11 has a lower edge 2.12 bent through 90° in the direction of the cell housing frame 2.3 in a lower region. In a modification of FIG. 6, the other cell housing side wall 2.2 has two tabs 2.22 bent through 90° in the direction of the cell housing frame 2.3 in an upper region. In assembly, the tabs 2.22 of the second housing side wall 2.2 grip next to the material elevation 2.31 onto the upper narrow side 2.32 of the cell housing frame 2.3, whilst the edge 2.12 of the first housing side wall 2.1 grips onto the lower narrow side of the cell housing frame 2.3.

FIG. 9 shows a battery 1 with a cell composite Z formed from a plurality of cells 2 as a further exemplary embodiment of the present invention in a schematised spatial exploded illustration.

To form the cell composite Z, the poles P+, P− of a plurality of cells 1 are electrically connected to one another in series and/or in parallel as a function of a desired electric voltage and power of the battery 1. Likewise as a function of the desired electric voltage and power of the battery 1, the cell composite Z can be formed from any desired number of cells 2 in developments of the invention.

A series electrical connection of the poles P+, P− of the cells 2 is realised by means of the electrical contacting of the cell housing side walls 2.1, 2.2 by adjacent cells 2 with different electric potential. In this case, the cell housing side wall 2.2 in particular of one of the cells 2 is electrically connected in a non-positive fitting, positive fitting and/or materially connected manner to the cell housing side wall 2.1 with the lug-like measuring connection 2.11 of an adjacent cell 2.

The battery 1, which is used for example in a vehicle, particularly a hybrid and/or electric vehicle, is formed in the exemplary embodiment illustrated from thirty cells 2 which are electrically connected to one another in series. For drawing and/or supplying electrical energy from and/or to the battery 1, an electrical connection element 10 is arranged on the cell housing side wall 2.2 of the first cell E1 of the cell composite Z, which in particular forms the positive pole P+ of the first cell E1. This connection element 10 is realised as an electrical connection lug and forms the positive pole connection Pₚₒₛ of the battery 1.

An electrical connection element 11 is also arranged on the cell housing side wall 2.1 of the last cell E2 of the cell composite Z, which in particular forms the negative pole P− of the latter cell E2. This connection element 11 is likewise realised as an electrical connection lug and forms the negative pole connection P_{neg} of the battery 1.

In the embodiment of the invention illustrated, the cell composite Z is thermally coupled to the heat-conducting plate 3. In this case, the cell housing side walls 2.1 are thermally coupled to the heat-conducting plate 3 directly or indirectly via a heat-conductive material, particularly a heat-conducting film 4, using the lower boundary 2.12 bent through 90° in the direction of the cell housing frame 2.3.

In a development of the invention, the heat conductive material can additionally or alternatively be formed from a casting compound and/or a paint.

For the purpose of a non-positive fitting connection of the cells 2 to the cell composite Z and a positive fitting connection of the heat-conducting plate 3 and the heat-conducting film 4 to the cell composite Z, the cell composite Z, the heat-conducting plate 3 and the heat-conducting film 4 are arranged in a housing frame.

This housing frame is formed in particular from one or a plurality of clamping elements, e.g. clamping straps 8, surrounding the cell composite Z completely, which clamping elements connect the cells 2 or the cell composite Z, the heat-conducting plate 3 and the heat-conducting film 4 in a non-positive fitting manner both in the horizontal and in the vertical direction.

In order to enable a secure holding of the clamping elements 8, material depressions 3.2 preferably corresponding to the dimensions of the clamping elements 8 are constructed on an underside of the heat-conducting plate 3.

In the upper region of the battery 1, the clamping elements 8 bear flat against the tabs 2.13 (FIG. 5) or 2.22 (FIG. 7). The clamping elements 8, clamping straps 8 here, are produced from a preferably non-electrically-conductive material which conducts heat well. Insofar as the clamping elements are produced from an electrically conductive material in one design variant, an electrical insulation is ensured by means of a coating or an intermediate layer between the upper side of the cells 2 and the clamping elements 8 and also between the exposed end faces of the first cell E1 and the last cell E2 and the clamping elements 8, in order to prevent a short circuit between elements.

Due to the heat-conducting contact of the clamping straps 8 on the upper side of the cells 2 and the heat-conducting properties of the clamping straps 8, a heat distribution on the upper side of the cells 2 and also a removal of heat accumulating there to the cooling plate 3 arranged on the underside of the battery 1 can be realised. In this manner, the cooling of such a battery 1 can be improved further.

The heat-conducting contact on the upper side of the cells 2 is benefited by the tabs 2.13 or 2.22 provided on the upper side, which are part of the flat cell side wall 2.1 or 2.2 exposed to the heat generated in the electrode stack 2.4 of the cell 2. In a further design variant, which is not illustrated in any more detail, in side regions, one of the housing side walls 2.1, 2.2 (cf. FIG. 6 or 8) has one side edge bent in each case through 90° in the direction of the cell housing frame 2.3, which in the assembly of the cell engage onto the lateral narrow sides of the cell housing frame 2.3. Such a design benefits heat transfer if a further clamping strap crossing the clamping straps 8 is provided in addition to the clamping bands 8 in FIG. 9, as is the case in the design variant shown in FIG. 5 (cf. reference number 9 there). The crossing clamping strap can be used for fixing the connection elements 10, 11.

In developments of the invention, which are not illustrated in any more detail, a few or all components, i.e. the cells 2, the heat-conducting plate 3, the heat-conducting film 4 or the entire battery 1, can alternatively or additionally be fitted in a battery housing in a partially or completely encapsulated manner.

If the battery 1 is for example a lithium ion high voltage battery, special electronics are generally required, which e.g. monitor and correct a cell voltage of the cells 2, a battery management system, which in particular controls a power consumption and output of the battery 1 (=battery control), and safety elements, which in the event of malfunctions of the battery 1, carry out a safe separation of the battery 1 from an electrical network.

In the exemplary embodiment of the invention illustrated, an electronic component 13 is provided, which at least contains devices for cell voltage monitoring and/or for a cell voltage compensation, which are not illustrated in any more detail. The electronic component 13 can also be constructed as an encapsulated electronic module in a development of the invention.

The electronic component 13 is arranged at the head side on the cell composite on the clamping elements 12 and the cell housing frame 2.3 of the cells 2. In order to achieve a bearing surface of the electronic component 13 and a fixing of the clamping elements 8 on the upper side of the cell composite Z at the same time, the material elevation 2.31 is constructed partially on the upper side of the frame 2.3 of each cell 2, the height of which corresponds in particular to the thickness of the clamping element 8. Non-positive fitting, positive fitting and/or materially connected connection technologies, which are not illustrated in any more detail, are used for fixing the electronic component 13 on the cell composite Z and/or on the clamping elements 8. Removal of heat generated in the electronic component 13 to the cooling plate 3 arranged on the underside of the battery 1 can also be realised via the clamping straps 8 against which the electronic component 13 bears. In this manner, the cooling of such an electronic component 13 can be improved further.

For an electrical contact of the cell composite Z with the electronic component 13, the lug-like measuring connections 2.11 arranged on the cell housing side walls 2.1 are guided through contact elements 13.3 arranged in the electronic component 13, which have a shape corresponding to the lug-like measuring connections 2.11.

Additionally, further electronic modules, which are not illustrated, are also provided, which for example contain the battery management system, the battery control, the safety elements and/or further devices for operating and for controlling the battery 1.

FIG. 11 shows a galvanic cell 2 constructed as a frame flat cell and a heat-conducting device 14 as a further exemplary embodiment of the present invention in a spatial view, wherein the frame flat cell 2 and the heat-conducting element 14 are illustrated separately from one another for the purpose of explanation.

According to the illustration in FIG. 11, the cell 2 is constructed similarly to the exemplary embodiment in FIG. 6 or 8. Unlike those, the cell housing side parts 2.1, 2.2 do not have any bent sections (2.12, 2.13 or 2.22 in FIGS. 6, 8), rather the dimensions (with the exception of the thickness) of the cell housing side parts 2.1, 2.2 correspond to those of the cell housing frame 2.3. It may be mentioned that the invention in the embodiment of this exemplary embodiment is also functional if the cell housing side parts 2.1, 2.2 of the cell 2 have bent sections as in FIGS. 6, 8.

The heat-conducting device 14 is constructed as a flat box with a base 14.1 and a narrow peripheral boundary 14.2. In this case, the base 14.1 forms a first flat side of the heat-conducting device 14 and the boundary 14.2 forms four narrow sides of the heat-conducting device, whilst an exposed edge 14.20 of the boundary 14.2 defines a second, open flat side of the heat-conducting device 14. The heat-conducting device 14 is produced in the present exemplary embodiment as a deep drawn part made of a material with good electrical and thermal conductor properties, preferably made of aluminium or steel or another metal.

The boundary 14.2 has a material recess 14.3 in an upper region in the centre. The width of the material recess 14.3 corresponds to the width of the material elevation 2.31 of the cell housing frame 2.3 of the cell 2 with play. The internal dimensions, particularly the internal height and internal width of the heat-conducting device 14 are adapted with little play to the external dimensions of the cell 2, so that the cell 2 finds space in the interior of the heat-conducting device 14 and can be inserted without force (cf. arrow “F” in FIG. 11). If the cell 2 heats up during operation and expands as a result, the cell housing may then bear securely against the boundary 14.2 of the heat-conducting element 14. The height of the boundary 14.2 is dimensioned in such a manner in this case that if the cell 2 bears by means of its cell housing side wall 2.2 against the base 14.1 of the heat-conducting device 14, the boundary 14.2 does not reach the other cell housing side wall 2.1.

The cell 2 with heat-conducting device 14 can be combined similarly to the manner illustrated in FIG. 3-5, 9 or 10 to form a cell block or a battery. In this case, the heat-conducting devices 14 on the one hand act as contacting between contact sections K1, K3 of successive cells, on the other hand, they transport heat generated in the interior of the cells 2 outwards via the respective bases 14.1 to the exposed boundaries 14.2, where the heat is either emitted directly to a cooling plate (below) or can be conducted via clamping devices (above) to the cooling plate. Analogously to the previously described exemplary embodiments and variants, provision is to be made for electrical insulation between the heat-conducting devices and the cooling plate or the clamping straps (cf. reference numbers 3, 8 in FIG. 9 inter alia), in order to prevent a short circuit.

In a design variant, the internal dimensions of the heat-conducting device 14 are not dimensioned with play, but rather with a slight undersizing with regards to the external dimensions of the cell 2, so that the heat-conducting device 14 and the cell 2 are to be joined with a certain force.

Although it is not illustrated in any more detail in the figure, depressions can be provided, which can be used for accommodating and guiding clamping straps.

FIG. 12 shows a modification of the heat-conducting device 14 according to FIG. 11 in a schematised spatial view.

According to the illustration in FIG. 12, the boundary 14.2 of the heat-conducting device has interruptions (cuts) 14.4 at the edges thereof, so that the continuous boundary 14.2 (FIG. 11) is divided into two lateral boundary sections 14.21, a lower boundary section 14.22 and two upper boundary sections 14.23. If the boundary is dimensioned with undersizing with respect to the cell 2, the joining force can be lower in this modification, as the boundary sections 14.21, 14.22, 14.23 can yield in a resilient manner. During production, the heat-conducting device 14 can initially be stamped or cut out of a flat sheet metal part and then bent into shape. Alternatively, the heat-conducting device 14 can be deep drawn and then cut out. FIG. 13 shows the construction of a different heat-conducting device 14 as a further exemplary embodiment of the present invention in a spatial view.

The heat-conducting device 14 is constructed as a flat box with a base 14.1 and a high peripheral boundary 14.2. In this case, the boundary 14.2 has a first flat side 14.21, a second flat side 14.22 and two narrow sides 14.23. The first flat side 14.21 has a tab 14.5 protruding at the upper boundary thereof. The base forms a third narrow side of the heat-conducting device 14, whilst an upper exposed edge 14.20 of the boundary 14.2 defines a fourth open narrow side of the heat-conducting device 14.

The heat-conducting device 14 is in turn produced e.g. as a deep drawn part made of a material with good electrical and thermal conductor properties, preferably made of aluminium or steel or another metal.

FIG. 14 shows a heat-conducting device 14 according to FIG. 13 with a battery cell 2 accommodated therein.

According to the illustration in FIG. 14, the cell 2 is constructed as a flat cell with a flat, housed electrode stack and two contacts 2.70 protruding from a narrow side of the cell 2 (here: the upper side), which form a negative pole connection P− and a positive pole connection P+ of the cell 2.

The tab 14.5 of the heat-conducting device 14 bent in the direction of an arrow “B” in FIG. 13 lies on the upper side of the cell 2. The current contacts 2.70 are freely accessible on the open side of the heat-conducting device 14. As the sides of the cell 2 bear closely against the walls 14.1, 14.21, 14.22, 14.23 of the heat-conducting device 14, heat generated in the interior of the cell 2 is emitted to the heat-conducting device 14.

FIG. 15 shows a battery 1 with a plurality of cells 2, which are accommodated in heat-conducting devices 14 according to FIG. 13 or 14, as a further exemplary embodiment of the present invention in a spatial illustration.

The cells 2 accommodated in the heat-conducting devices 14 together form a cell block or cell composite Z. Current contacts 2.7 of the cells 2 are connected in the exemplary embodiment illustrated to form a series circuit.

In the battery 1 of this exemplary embodiment, a cooling plate 3 is provided, which is arranged on an end face of the cell block. The cells 2 with heat-conducting devices 14 and the cooling plate 3 rest on a base plate 15. A clamping strap 9 surrounds the cell block Z and the cooling plate 3 in a horizontal plane and is therefore also termed a horizontal clamping strap 9. A clamping strap 8 surrounds the cell block Z, the cooling plate 3 and the base plate 15 in a vertical plane and is therefore also termed a vertical clamping strap 8. In this manner, the cell block Z, the cooling plate 3 and the base plate 15 are clamped in a crossed-over manner. As the horizontal clamping strap 9 bears against the lateral narrow sides of the heat-conducting devices 14, the horizontal clamping strap 9 can absorb heat there and emit the same to the cooling plate 3. As the vertical clamping strap 8 bears against the upper narrow sides and there onto the bent tabs 14.5 of the heat-conducting devices 14, the vertical clamping strap 8 can absorb heat there and emit the same to the cooling plate 3.

Although not illustrated in any more detail in the figure, the cooling plate 3 can have depressions for accommodating the horizontal clamping strap 9, which may be dimensioned in such a manner that the vertical clamping strap 9 bears in a planar manner against upper surfaces of the cooling plate 3 and the horizontal clamping strap 8. The walls of the heat-conducting device 14 can also have depressions for accommodating the clamping straps 8, 9, and the base plate can have a depression for accommodating the vertical clamping strap 8.

In a design variant, the base plate 15 is produced from a heat-conducting material and contributes to heat transport and to heat distribution within the cell block Z.

In an alternative design variant, the base plate 15 is produced from a heat-insulating material. The vertical clamping strap 8 can in this design variant be guided in the interior of the base plate, for example through a horizontally running slot.

In a further design variant, the vertical clamping strap 8 is part of the base plate 15 or securely connected to the same.

In a further modification, which is not illustrated in any more detail, a heat-conducting element similar to the heat-conducting element 14 in FIG. 13 is adapted for accommodating a flat cell with current contacts 2.7 arranged on opposite narrow sides. Such a heat-conducting element can be constructed as a sheath, which is open on both sides, made of a heat-conducting material. Insofar as the current contacts in such a cell extend over the entire width of the respective narrow sides and the construction of bendable tabs (cf. 14.5 in FIGS. 13, 14) above that is out of the question, the heat dissipation only takes place via the closed narrow sides in such a heat-conducting element. In such a case, further heat dissipation can be provided via the current contacts.

FIG. 16 shows a battery 1 as a further exemplary embodiment of the present invention in a spatial illustration.

According to the illustration in FIG. 1, a plurality of cells 2 are arranged between two holding frames 16, 16 or 16, 17 in each case. The arrangement made up of cells 2 and holding frames 16, 17 is arranged between two end plates 18, 19. Four tie bolts 20 with locknuts 21 are provided for clamping the composite made up of cells, holding frames 16, 17 and end plates 18, 19.

The end plates 18, 19 are also used as electric poles of the battery 1. Corresponding connection devices 23, 24 are provided for connection. A control device 26 attached to struts 25 is provided for monitoring state parameters of the battery 1 and the individual cells 2, for charge compensation and the like. In order to prevent a short circuit between the end plates 18, 19, the tie bolts 20 and/or the locknuts 21 are electrically insulated with respect to at least one of the end plates 18, 19.

In this exemplary embodiment, the tie bolts 20 absorb heat generated in the interior of the battery 1. They are in heat-conducting contact with the end plates 18, 19. The heat can be conducted away via the end plates 18, 19 by means of a suitable cooling device (not illustrated in any more detail).

For example, a profile made from aluminium or another good heat conductor, around which air flows and which is screwed by means of tie bolts on the head side and/or the nut side to the end plates 18, 19, is considered as cooling device. Alternatively, a heat exchanger, to which the tie bolts 20 can emit heat, can also be attached like in FIG. 15 at the end on one of the end plates 18, 19. Other types of heat dissipation via the tie bolts 20 are also conceivable.

Although not illustrated in any more detail in the figure, the cells 2 in this exemplary embodiment are constructed as so-called coffee bag or pouch cells (cf. also the cell illustrated in FIG. 19). Such cells 2 have an electrode stack and a housing made of a film material (film wrapper), which is sealed at a boundary section, in order to form a so-called sealing seam. In this case, the contacts pass through the sealing seam at two narrow sides of the cells 2. The cells 2 are gripped by the holding frames 16, 17 at the contacts themselves or in contact regions, which pass through in the region of the sealing seam where the contacts pass through the sealing seam, and emit heat to the frame elements 16, 17 at least there via the contacts. The tie bolts run through the frame elements 16, 17 and absorb heat from the holding frames 16, 17, which are in contact with the contacts. Alternatively, separate contact elements can be provided, which are gripped by the holding frames 16, 17 and exert the compressive force onto the boundary sections of the cells 2 and absorb heat from the same. Further alternatively, heat from the flat sides of the cells 2 can be transmitted via heat-conducting plates and/or heat-conducting elastic elements (cf. FIGS. 19, 20), which are arranged between the cells 2, to the holding frames 16, 17 and in turn conducted away again via the tie bolts 20.

In further design variants, more than four tie bolts, e.g. six or eight tie bolts can be provided in order to clamp the cell block and dissipate heat.

Alternatively, in the case of this shape of a cell block, the clamping can also take place for example by means of heat-conducting clamping straps (cf. FIGS. 1-5 inter alia). In a further design variant, such clamping straps can for example but not only be guided via bevels 16.1, 17.1, 18.1, 19.1 of the holding frames 16, 17 and the end plates 18, 19.

FIG. 17 shows the construction of a battery 1 as a further exemplary embodiment of the present invention in a schematic illustration.

The battery 1 is constructed from a plurality of individual cells (cells) 2 which are arranged in three rows R1 to R3. A first row R1 is arranged adjoining a battery housing wall 27, whilst the rows following the same are in each case arranged at a distance of one row width further from the battery housing wall 27. One cell 2 from each row R1 to R3 is illustrated in the figure, whilst the further cells of the rows are symbolised by dots. Battery cells adjoining one another transversely to the direction of extent of the rows R1 to R3 define a column Si of cells 2.

The cells 2 of the battery 1 of this exemplary embodiment are cylindrically constructed cells 2. The cells 2 of a column Si are fixed by means of a looped fixing strap 28 on the battery housing wall 27. The fixing strap 28 runs from the battery housing wall 27 and surrounds the cells 2 of the column Si initially in a wave-shaped manner as far as the cell 2 of the most remote row R3, surrounds the same further in a loop and then runs back to the battery housing wall 27, wherein it in turn surrounds the cells 2 of the column Si in a wave-shaped manner in the reverse order to before. In this manner, the cells 2 of a column Si are held in their position.

The fixing strap 28 is produced from a heat-conducting material. By surrounding the cells 2, it is in close contact with the same, absorbs heat which is generated in the cells 2 and transports the same to the battery housing wall 27. The battery housing wall 27 is actively or passively cooled or temperature controlled.

FIG. 18 shows the construction of a battery 1 as a further exemplary embodiment of the present invention in a schematic illustration. This exemplary embodiment is a modification of the exemplary embodiment illustrated in FIG. 17. Here, the cell 2 of the three rows R1 to R3 are located between two housing side walls 27.1, 27.2. Two fixing straps 28.1, 28.2 run between the housing side walls 27.1, 27.2, wherein they surround the battery cells 2 in a wave-shaped manner.

The fixing straps 28 or 28.1, 28.1 of the batteries 1 illustrated in FIGS. 17, 18 are produced from an elastic material that can preferably be bent well.

It is understood that the invention is not orientated to a certain plurality of columns Si; rather, the invention according to the previously described exemplary embodiments can also be applied to batteries which only have one column S of battery cells 2.

It is further understood that the invention is not limited to three rows R1 to R3 of battery cells 2; rather, the invention according to the previously described exemplary embodiments can also be applied to batteries which have more or fewer rows Ri of battery cells 2.

Although an assumption about elongated cylindrical cells 2 was made in FIGS. 17, 18, in a design variant, a stack of flat cylindrical cells, for example button cells or the like can be provided in the place thereof, which are pressed against one another in the axial direction by means of a further clamping device which is not illustrated.

FIG. 19 shows the construction of a battery cell 2 as a further exemplary embodiment of the present invention in a spatial illustration.

The battery cell 2 of this exemplary embodiment is a so-called coffee bag or pouch cell, the flat, approximately cuboidal electrode stack (active part) of which is wrapped in a film which is sealed in the boundary region and forms a so-called sealing seam 2.8. Current contacts 2.70 of the cell 2 extend through the sealing seam 2.8. Without limiting the generality, the current contacts 2.70 of the cell 2 are arranged on opposite narrow sides, preferably the shorter narrow sides of the cell 2.

Elastic means (cushions) 29 are attached, e.g. adhesively bonded or the like, on the flat sides of the cell 2. The cushions 29 are used for elastically supporting the cell 2 with respect to other cells or a battery housing frame or a frame element and are suitable to compensate thermal expansions or cushion impacts. The cushions 29 have good heat conduction properties. To this end, a resilient material, which is itself not constructed in a particularly heat-conducting manner, such as for example PU foam, foam rubber or the like is arranged in a shell (film or the like) which conducts heat well. The shell is preferably constructed in a self flexible or bellows-like manner, in order to be able to follow the movements of the resilient material.

In a modification, the resilient material, which can be arranged in a special shell but does not have to be, has inherent heat-conducting properties. This is for example a heat-conducting gel, an arrangement of metal springs, chips or the like, or a foam doped with metal particles.

Due to the heat-conducting properties of the cushions 29, a thermal compensation between adjacent cells 2 can be facilitated. In the event that heat-conducting means, such as for example heat-conducting plates or the like, are arranged between adjacent cells 2, an effective heat dissipation from a cell composite made up of cells 2 can also be realised without having to provide an active cooling in the interior of the cell composite. The heat-conducting means, such as for example heat-conducting plates or the like, can be coupled to a cooling plate or the like, as is illustrated e.g. in FIG. 1.

FIG. 20 shows the construction of a heat-conducting device 30 as a further exemplary embodiment of the present invention in a cross-sectional view.

The heat-conducting device 30 of this exemplary embodiment has a support structure 30.1 and two elastic layers 30.2. The support structure 30.1 is produced from a material which conducts heat well, such as for example aluminium or a different metal, a heat-conducting plastic or the like. In cross section, it has the shape of a T profile with a long leg 30.11 and two short legs 30.12. The long leg 30.11 is provided for arrangement between battery cells 2 (illustrated as dashed outlines 2) of a cell composite, in order to absorb heat produced in the battery cells 2. The short legs 30.12 are provided for bearing against a heat-conducting plate 3 (illustrated as a dotted outline 3) or the like, in order to emit the heat absorbed from the battery cells 2.

Elastic layers 30.2 are arranged, e.g. adhesively bonded or the like, on both sides of the long leg 30.11. The elastic layers 30.2 are used for elastically supporting the cells 2 with respect to one another and are suitable to compensate thermal expansions of the cells 2 or cushion impacts. The elastic layers 30.2 have good heat conduction properties. To this end, a resilient material, which is itself not constructed in a particularly heat-conducting manner, such as for example PU foam, foam rubber or the like is arranged in a shell (film or the like) which conducts heat well. The shell is preferably constructed in a self flexible or bellows-like manner, in order to be able to follow the movements of the resilient material.

In a modification, the resilient material, which can be arranged in a special shell but does not have to be, has inherent heat-conducting properties. This is for example a heat-conducting gel, an arrangement of metal springs, chips or the like, or a foam doped with metal particles.

Due to the heat-conducting properties of the elastic layers 30.2, a thermal compensation between adjacent cells 2 can be facilitated and an effective heat dissipation from a cell composite made up of cells 2 can be realised without having to provide an active cooling in the interior of the cell composite.

In a modification, the elastic layers 30.22 can extend onto the short legs 30.12 in order to also achieve a downward cushioning.

An electrically insulating heat-conducting film or the like can be provided between the short legs 30.22 and the cooling plate 3.

Although the present invention has previously been described with reference to concrete exemplary embodiments in terms of its essential features, it goes without saying that the invention is not limited to these exemplary embodiments, but rather can be modified and expanded in the scope and field predetermined by the patent claims.

Thus, the invention is in no way limited to flat or cylindrical cells of lithium ion type, rather in its basic concept, it can be applied to all types of energy storage apparatus, such as for example primary and secondary cells of different electrochemical composition and function, fuel cells, capacitors, particularly high-performance capacitors, such as for example supercaps or the like.

It is understood that insofar as it is technically possible, individual features of each of the previously described exemplary embodiments, variants and modifications shown in the figures can be used in any other of the exemplary embodiments, variants and modifications.

A battery 1 or a cell composite or cell block Z are examples for an energy storage device in the sense of the invention. Cells 2 are examples for storage cells in the sense of the invention. Clamping straps 8, 9, tie bolts 20 and fastening straps 28, 28.1, 28.2 are examples for a clamping device or for clamping elements in the sense of the invention. Holding frames 16, 17 are examples for holding elements in the sense of the invention. Cooling plates 3 are examples for a heat-exchanger device in the sense of the invention. A coolant is a heat transfer agent in the sense of the invention.

### LIST OF REFERENCE NUMBERS

1 Battery
2 Cell
2.1 Cell housing side wall
2.11 Measuring connection
2.2 Cell housing side wall
2.3 Cell housing frame
2.31 Material elevation
2.32 Upper narrow side
2.33 Material recess
2.34 Material recess
2.4 Electrode stack
2.5 Electrode film
2.6 Separator
2.7 Contact lug
2.70 Pole contact (current contact)
2.8 Sealing seam
2.9 Fold
2.10 Flat side
3 Cooling plate
3.1 Coolant connection
3.2 Depression
3.3 Cooling channel
4 Heat-conducting film
5 Pressure plate
5.1 Depression
6 Front pole plate
7 Rear pole plate
6.1, 7.1 Lug-like elongation
6.2, 7.2 Fixing nose
7.3 Depression
8 Clamping element
8.1 Spring zone
8.20, 8.21, 8.22 Heat-conducting element
8.3 Crimp closure
8.4 Clamping region
8.5 Coating
9 Clamping strap
10 Electrical connection element
11 Electrical connection element
13 Electronic component
13.1 Device for monitoring cell voltage
13.2 Device for compensating cell voltage
13.3 Contact element
14 Heat-conducting element
14.1 Base
14.2 Boundary
14.20 Edge
14.21, 14.22, 14.23 Boundary sections
14.3 Recess
14.4 Cuts
14.5 Tab
15 Base plate
16, 17 Holding frame
16.1, 17.1 Bevel
18, 19 End plates
18.1, 19.1 Bevel
20 Tie bolt
21 Nut
22, 23, 24 Connection device
25 Strut
26 Control device
27, 27.1, 27.2 Housing wall
28, 28.1, 28.2 Fixing strap
29 Cushion (elastic means)
30 Heat-conducting element
30.1 Carrier structure
30.11 Long leg
30.12 Short leg
30.2 Elastic layer
30.21 Resilient material
30.22 Shell
B Bending direction
E1 First cell
E2 Last cell
F Joining direction
b Width
h Height
K1 to K3 Voltage connection contacts
P+Positive pole
P− Negative pole
P_{neg} Negative pole connection
Pₚₒₛ Positive pole connection
t Depth, thickness
z Cell composite

It is pointed out that the preceding list of reference numbers is an integral part of the description.

1-15. (canceled)

16. An energy storage apparatus, comprising:
a plurality of storage cells;
a clamping device configured to clamp the storage cells;
a cooling device for controlling the temperature of the storage cells or of a cell composite formed by the storage cells, wherein the clamping device is configured and set up as a functional constituent of the temperature control device; and
at least one elastically resilient damping element, which is constructed in a heat-conducting manner, provided between two storage cells.

17. The energy storage apparatus according to claim 16, wherein the clamping device is constructed with a heat-conducting material.

18. The energy storage apparatus according to claim 16, wherein the clamping device bears against heat exchange surfaces of the storage cells at least in certain sections,

19. The energy storage apparatus according to claim 18, wherein the clamping device bears against heat exchange surfaces of the storage cells in a planar manner.

20. The energy storage apparatus according to claim 16, wherein the storage cells have a prismatic, particularly a flat shape and heat exchange surfaces are provided on at least one of the peripheral sides, particularly on narrow sides, of the storage cells.

21. The energy storage apparatus according to claim 16, further comprising heat-conducting elements, which are constructed with a heat-conducting material and bear at least in certain sections against heat exchange surfaces of the storage cells, wherein the clamping device bears against the heat-conducting elements at least at exposed surfaces.

22. The energy storage apparatus according to claim 21, wherein the heat-conducting elements bear planarly against the heat exchange surfaces of the storage cells.

23. The energy storage apparatus according to claim 16, wherein the clamping device includes at least one clamping strap which is constructed with the heat-conducting material and which is constructed at least in certain sections in an inherently resilient, particularly wave-spring-shaped, manner.

24. The energy storage apparatus according to claim 16, wherein the clamping device includes a plurality of clamping straps each of which is constructed with the heat-conducting material and is constructed at least in certain sections in an inherently resilient, particularly wave-spring-shaped, manner, wherein at least one clamping strap of the plurality of clamping straps covers at least one other clamping strap of the plurality of clamping straps.

25. The energy storage apparatus according to claim 16, wherein the clamping device includes a plurality of tie bolts which are constructed with the heat-conducting material.

26. The energy storage apparatus according to claim 16, wherein
the clamping device includes holding elements and clamping elements,
the holding elements are arranged alternately with the storage cells in order to hold the storage cells therebetween,
the clamping elements clamp the holding elements with the storage cells,
the holding elements are thermally coupled at least in certain sections to heat exchange surfaces of the storage cells, and
the clamping elements bear at least in certain sections against heat exchange surfaces of the holding elements.

27. The energy storage apparatus according to claim 16, wherein the clamping device is thermally coupled at least in certain sections, particularly by means of planar contact, with sections of a heat exchanger device,

28. The energy storage apparatus according to claim 27, wherein the heat exchanger device is attached to a heat transfer agent circuit and wherein the heat transfer agent circuit is configured to be controlled or regulated.

29. The energy storage apparatus according to claim 27, wherein the heat exchanger device bears against heat exchange surfaces of the storage cells at least in certain sections, wherein the storage cells have a flat prismatic shape and heat exchange surfaces are provided on at least two narrow sides of the storage cells.

30. The energy storage apparatus according to claim 29, wherein the at least two narrow sides of the storage cells are opposite sides of the storage cells.

31. The energy storage apparatus according to claim 16, wherein at least one damping element is part of a storage cell or part of a heat-conducting element or is attached on surfaces of a storage cell or a heat-conducting element or is arranged between storage cells and a heat-conducting element.
